(19) United States
(12) Patent Application Publication
(10) Pub. No.: US 2026/0228687 A1
(43) Pub. Date: Aug. 6, 2026

(54) SERVER DEVICE, INFORMATION PROCESSING METHOD, AND NON-TRANSITORY STORAGE MEDIUM

(71) Applicant: TOYOTA JIDOSHA KABUSHIKI KAISHA, Aichi-ken (JP)

(72) Inventors: Iwao NITTA, Nagoya-shi, Aichi-ken (JP); Teruyoshi FUJIWARA, Toyota-shi, Aichi-ken (JP); Ryota SUZUKI, Ikeda-shi, Osaka (JP)

(21) Appl. No.: 19/149,847

(22) PCT Filed: Dec. 21, 2023
(86) PCT No.: PCT/IB2023/063101

§ 371 Date: Jul. 22, 2025

(30) Foreign Application Priority Data
Jan. 27, 2023 (JP) 2023-011228

(51) Int. Cl. G06Q 10/087

(52) U.S. Cl. CPC G06Q 10/08744

(57) ABSTRACT

A server device includes a storage device and a control unit. The control unit is configured to execute receiving, from an account of the upstream company, a permission command including designation of the downstream company permitted to access pieces of first product information. The control unit is configured to execute receiving, from an account of the downstream company, a linking request including selection of the first product information to which second product information is to be linked from the pieces of the first product information the downstream company is permitted to access. The control unit is configured to execute generating linking information indicating a linking relationship between the first product information and the second product information that are designated by the linking request received from the account of the downstream company.

### BACKGROUND OF THE INVENTION

### 1. Field of the Invention

The present disclosure relates to server devices, information processing methods, and non-transitory storage media.

### 2. Description of Related Art

There is known a system in which information is shared between or among a plurality of companies constituting a supply chain. For example, Japanese Unexamined Patent Application Publication No. 2004-171146 (JP 2004-171146 A) discloses a system in which product information is shared between adjacent suppliers.

### SUMMARY OF THE INVENTION

The present disclosure provides a server device, information processing method, and non-transitory storage medium that collect information on a supply chain.

A server device according to a first aspect of the present disclosure includes a storage device and a control unit. The storage device is configured to store, for each of companies included in a supply chain, pieces of product information on products of the companies. The supply chain has a structure of three or more levels. An upstream company and a downstream company are defined between companies in every two adjacent hierarchical levels of the supply chain. The control unit is configured to execute receiving, from an account of the upstream company, a permission command including designation of the downstream company permitted to access pieces of first product information. The pieces of the first product information are pieces of information on upstream products of the upstream company. The control unit is configured to execute receiving, from an account of the downstream company, a linking request including selection of the first product information to which second product information is to be linked from the pieces of the first product information the downstream company is permitted to access. The second product information is information on a downstream product of the downstream company. The control unit is configured to execute generating linking information indicating a linking relationship between the first product information and the second product information that are designated by the linking request received from the account of the downstream company.

In the server device according to the first aspect of the present disclosure, the product information may include traceability-related information. The control unit may be configured to execute acquiring first traceability-related information included in product information of one or more incorporated products in a target product and second traceability-related information included in product information on the target product. The one or more incorporated products may be one or more products identified from the linking information related to the target product. The control unit may be configured to execute integrating the first traceability-related information and the second traceability-related information. The control unit may be configured to execute outputting a result of the integrating.

In the server device according to the first aspect of the present disclosure, the first traceability-related information and the second traceability-related information may include information on an amount of greenhouse gas emissions. The integrating the first traceability-related information and the second traceability-related information may include integrating amounts of the greenhouse gas emissions for the one or more incorporated products and the target product to calculate a total amount of the greenhouse gas emissions related to manufacturing activities performed until the target product is manufactured.

In the server device according to the first aspect of the present disclosure, the first traceability-related information and the second traceability-related information may include a recycling rate of a predetermined raw material. The integrating the first traceability-related information and the second traceability-related information may include integrating recycling rates of the predetermined raw material in the one or more incorporated products and the target product to calculate an overall recycling rate of the predetermined raw material in the target product.

In the server device according to the first aspect of the present disclosure, the first traceability-related information and the second traceability-related information may include a score for due diligence. The integrating the first traceability-related information and the second traceability-related information may include integrating scores for the due diligence of the one or more incorporated products and the target product to calculate an overall score for the due diligence of the target product.

In the server device according to the first aspect of the present disclosure, generating linking information may include creating a product tree by associating the first product information and the second product information in such a manner that the upstream product corresponding to the selected first product information is a child node and the downstream product corresponding to the second product information is a parent node. The acquiring the first traceability-related information and the second traceability-related information, and the integrating the first traceability-related information and the second traceability-related information may include, in the product tree to which the target product belongs as a root node between the companies in the every two adjacent hierarchical levels from a most upstream product belonging to the product tree as a leaf node to the target product, repeating (i) transferring the first traceability-related information of the upstream product to the downstream product, (ii) integrating the transferred first traceability-related information of the upstream product and the second traceability-related information derived from the downstream product, and (iii) acquiring a result of the integrating as third traceability-related information of the downstream product.

In the server device according to the first aspect of the present disclosure, the control unit may be configured to receive a participation invitation including designation of the upstream company from the account of the downstream company. The control unit may be configured to transmit a participation request to an address of the designated upstream company in response to the received participation invitation. The control unit may be configured to generate the account of the upstream company according to a response to the participation request. The receiving the permission command from the account of the upstream company may be performed after the generating the account of the upstream company.

In the server device according to the first aspect of the present disclosure, the storage device may be configured to further store transaction data on the upstream product between the upstream company and the downstream company. At least one of the receiving the permission command from the account of the upstream company and the receiving the linking request from the account of the downstream company may be performed using the transaction data.

An information processing method according to a second aspect of the present disclosure is performed by a server device. The server device is configured to store, for each of companies included in a supply chain, pieces of product information on products of the companies. The supply chain has a structure of three or more levels. An upstream company and a downstream company may be defined between companies in every two adjacent hierarchical levels of the supply chain. The information processing method includes: receiving, from an account of the upstream company, a permission command including designation of the downstream company permitted to access pieces of first product information; receiving, from an account of the downstream company, a linking request including selection of the first product information to which second product information is to be linked from the pieces of the first product information the downstream company is permitted to access; and generating linking information indicating a linking relationship between the first product information and the second product information that are designated by the linking request received from the account of the downstream company. The pieces of the first product information are pieces of information on upstream products of the upstream company. The second product information is information on a downstream product of the downstream company.

In the information processing method according to the second aspect of the present disclosure, the product information may include traceability-related information. The information processing method may further include: acquiring first traceability-related information included in product information of one or more incorporated products in a target product and second traceability-related information included in product information on the target product; integrating the first traceability-related information and the second traceability-related information; and outputting a result of the integrating. The one or more incorporated products may be one or more products identified from the linking information related to the target product.

In the information processing method according to the second aspect of the present disclosure, the first traceability-related information and the second traceability-related information may include information on an amount of greenhouse gas emissions. The integrating the first traceability-related information and the second traceability-related information may include integrating amounts of the greenhouse gas emissions for the one or more incorporated products and the target product to calculate a total amount of the greenhouse gas emissions related to manufacturing activities performed until the target product is manufactured.

In the information processing method according to the second aspect of the present disclosure, the first traceability-related information and the second traceability-related information may include a recycling rate of a predetermined raw material. The integrating the first traceability-related information and the second traceability-related information may include integrating recycling rates of the predetermined raw material in the one or more incorporated products and the target product to calculate an overall recycling rate of the predetermined raw material in the target product.

In the information processing method according to the second aspect of the present disclosure, the first traceability-related information and the second traceability-related information may include a score for due diligence. The integrating the first traceability-related information and the second traceability-related information may include integrating scores for the due diligence of the one or more incorporated products and the target product to calculate an overall score for the due diligence of the target product.

In the information processing method according to the second aspect of the present disclosure, generating linking information may include creating a product tree by associating the first product information and the second product information in such a manner that the upstream product corresponding to the selected first product information is a child node and the downstream product corresponding to the second product information is a parent node. The acquiring the first traceability-related information and the second traceability-related information, and the integrating the first traceability-related information and the second traceability-related information may include, in the product tree to which the target product belongs as a root node between the companies in the every two adjacent hierarchical levels from a most upstream product belonging to the product tree as a leaf node to the target product, repeating (i) transferring the first traceability-related information of the upstream product to the downstream product, (ii) integrating the transferred first traceability-related information of the upstream product and the second traceability-related information derived from the downstream product, (iii) and acquiring a result of the integrating as third traceability-related information of the downstream product.

The information processing method according to the second aspect of the present disclosure may further include: receiving a participation invitation including designation of the upstream company from the account of the downstream company; transmitting a participation request to an address of the designated upstream company in response to the received participation invitation; and generating the account of the upstream company according to a response to the participation request. The receiving the permission command from the account of the upstream company may be performed after the generating the account of the upstream company.

In the information processing method according to the second aspect of the present disclosure, at least one of the receiving the permission command from the account of the upstream company and the receiving the linking request from the account of the downstream company may be performed using transaction data on the upstream product between the upstream company and the downstream company.

A non-transitory storage medium according to a third aspect of the present disclosure is configured to store instructions that are executable by one or more processors and that cause the one or more processors to perform functions. The functions include: communicating with a server device configured to store, for each of companies included in a supply chain, pieces of product information on products of the companies; acquiring, from the server device, pieces of first product information to which access is permitted; and transmitting to the server device a linking request including selection of the first product information to which second product information is to be linked from the pieces of the first product information to which access is permitted. The supply chain has a structure of three or more levels. An upstream company and a downstream company are defined between companies in every two adjacent hierarchical levels of the supply chain. The pieces of first product information to which access is permitted are pieces of information on upstream products of the upstream company and are pieces of information the downstream company is permitted to access. The second product information is information on a downstream product of the downstream company.

In the non-transitory storage medium according to the third aspect of the present disclosure, the functions may further include transmitting the first product information and the second product information to the server device.

In the non-transitory storage medium according to the third aspect of the present disclosure, the functions may further include transmitting a participation invitation including designation of the upstream company to the server device.

Other aspect of the present disclosure provides a program configured to cause a computer to perform the above method, or a computer-readable storage medium storing the program in a non-transitory manner.

According to the present disclosure, it is possible to collect information on a supply chain.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 illustrates a supply chain according to a first embodiment;

FIG. 2 illustrates relationships among products supplied by the supply chain;

FIG. 3 shows an outline of a process that is performed between company terminals and a server device;

FIG. 4 shows a hardware configuration of the server device according to the first embodiment;

FIG. 5 shows a hardware configuration of the company terminal according to the first embodiment;

FIG. 6 shows a software configuration of the server device according to the first embodiment;

FIG. 7 shows a software configuration of the company terminal according to the first embodiment;

FIG. 8 shows an example of product information generated by a product information generation unit;

FIG. 9A shows an example of a screen output by a privilege setting unit;

FIG. 9B shows an example of permission information generated by the privilege setting unit based on input information;

FIG. 10 shows an example of a user interface including a list of products that are linking candidates;

FIG. 11 shows a flow of a process that is performed by the server device;

FIG. 12 illustrates a plurality of pieces of product information linked together;

FIG. 13 illustrates a product tree and amounts of carbon dioxide emitted in each process;

FIG. 14 shows an example of a screen in which the product tree is output as an image;

FIG. 15 shows an example of the product tree in which the products a company is not authorized to access are hidden;

FIG. 16 is a sequence diagram illustrating a process that is performed by the server device and the company terminal in first to third phases;

FIG. 17 is a sequence diagram illustrating a process that is performed by the server device and the company terminal in a fourth phase;

FIG. 18 shows a software configuration of a server device according to a second embodiment;

FIG. 19 shows a software configuration of a company terminal according to the second embodiment;

FIG. 20 is a sequence diagram illustrating a process that is performed by the server device and the company terminals in the second embodiment; and

FIG. 21 is a sequence diagram illustrating a process that is performed by a server device and a company terminal in a third embodiment.

### DETAILED DESCRIPTION OF EMBODIMENTS

In recent years, there has been a demand to trace the amounts of greenhouse gases emitted during manufacture of products such as automobiles and batteries, that is, to trace carbon footprints.

It is herein assumed that products are supplied by a supply chain including a plurality of companies. In one example, at least part of companies (intermediate suppliers) in the supply chain may receive components from one or more upstream companies, produce their own products using the received components, and deliver the produced products to companies in the next step (downstream companies). The most upstream companies may directly produce their own products and deliver the produced products to companies in the next step. Part of the companies in the supply chain may deliver products received from other companies to different companies as they are (i.e., may be involved in distribution). A plurality of companies repeats this process, and a final product is obtained in the final step.

In the case of obtaining automotive products, the supply chain may be constituted by an original equipment manufacturer (OEM) and a plurality of suppliers. The OEM may be a company that assembles a final product (most downstream company), and the suppliers may be companies that supply components, materials, assemblies, etc. for producing the final product. The companies included in the supply chain may be determined based on the products.

In the following description, the components etc. produced by the suppliers will be referred to as “products,” and the product in the final step will be referred to as “final product.” In one example, the final product may be supplied to consumers. The suppliers and OEM included in the supply chain will be simply referred to as “companies.” A plurality of hierarchical levels of the supply chain will be referred to as “tiers.”

For example, in order to calculate the total amount of greenhouse gases emitted during manufacture of a final product in such a system, it is necessary to clarify product supply relationships among a plurality of companies. This is because it is difficult to correctly calculate the total amount of greenhouse gases emitted in a plurality of steps unless the relationships among a plurality of products constituting the final product are clear. In order to solve this problem, for example, a process of generating a tree showing supply relationships among a plurality of products constituting a final product (hereinafter referred to as “product tree”) is necessary.

It is possible to cause each company other than the most downstream company to provide information indicating their product supply relationships with a plurality of companies. However, since information such as companies' business partners, detailed information on their own products, and their material suppliers is sensitive, such information should be disclosed only to limited entities. That is, in the existing systems, it is difficult to trace carbon footprints while maintaining confidentiality. A server device of the present disclosure solves such a problem.

A server device according to an aspect of the present disclosure is a server device including: a storage device configured to store, for each of companies included in a supply chain, pieces of product information on products of the companies; and a control unit. The supply chain has a structure of three or more levels. In every adjacent two hierarchical levels, a company on the upstream side is defined as an upstream company, and a company on the downstream side is defined as a downstream company. The control unit is configured to: receive, from an account of the upstream company, a permission command including designation of the downstream company permitted to access pieces of first product information, the pieces of first product information being pieces of information on upstream products of the upstream company; receive, from an account of the downstream company, a linking request including selection of the first product information to which second product information is to be linked from the pieces of first product information the downstream company is permitted to access, the second product information being information on a downstream product of the downstream company; and generate, in response to the received linking request, linking information indicating a relationship of linking designated by the linking request.

In the supply chain, the company located on the upstream side delivers a product to the company located on the downstream side. The most downstream company is a company that assembles a final product (OEM). When looking at certain hierarchical levels in the supply chain, a company located on the upstream side is defined as an upstream company, and a company located on the downstream side is defined as a downstream company. A product of the upstream company will be referred to as “upstream product,” and a product of the downstream company will be referred to as “downstream product.” The upstream product can be said to be a product constituting (incorporated in) the downstream product. Information on the upstream product will be referred to as “first product information,” and information on the downstream product will be referred to as “second product information.”

The server device according to the present disclosure stores pieces of product information for each company, and performs a process of linking the pieces of product information (i.e., a process of associating the downstream product and the upstream product) based on a linking request acquired from an account of each company. The linking request is a request to link pieces of product information (i.e., upstream product information and downstream product information). The control unit generates linking information in response to the linking request and stores the generated linking information in the storage device. The linking information is information indicating a linking relationship between the information on the downstream product and the information on the upstream product. By repeating this process, the server device can create a product tree associated with the final product.

The pieces of product information can be linked when a downstream company that produces a downstream product designates an upstream product to which the downstream product is to be linked. When there are many suppliers, it is possible to designate an upstream product by selecting from a list. However, it is not preferable from the viewpoint of information protection to list pieces of information on all the companies and all the products in the supply chain.

Therefore, the server device according to the present disclosure causes the upstream company to designate in advance the downstream company permitted to access the information on the product of the upstream company (first product information), and discloses, to the downstream company, only the product information the downstream company is permitted to access. The downstream company selects (or designates) product information to which the product of the download company is to be linked from the pieces of product information the downstream company is permitted to access by the upstream company. The permission command is a command to designate the downstream company permitted to access the first product information, namely the information on the upstream product.

With the server device according to the present disclosure, it is possible to clarify the supply relationships of a plurality of products among a plurality of companies. The upstream company permits only its adjacent downstream company in the supply chain to access the information on the product of the upstream company. This is advantageous in that unnecessary disclosure of the information is avoided.

The product information stored in the server device may include traceability-related information. The traceability-related information is typically information for calculating an amount of greenhouse gas emission, a recycling rate of a raw material, or a score for due diligence.

In this case, the control unit may further be configured to: acquire traceability-related information included in product information of one or more incorporated products in a target product and traceability-related information included in product information on the target product, the one or more incorporated products being identified from linking information related to the target product; integrate the traceability-related information acquired for the one or more incorporated products and the traceability-related information acquired for the target product; and output a result of the integrating.

The control unit acquires traceability-related information of a certain target product (that need not necessarily be a final product), acquires traceability-related information of an incorporated product, and integrates these acquired pieces of traceability-related information. The incorporated product is one or more products included in the target product and produced on the upstream side of the target product. Integrating the pieces of traceability-related information makes it possible to trace the amount of greenhouse gas emission etc. at any desired hierarchical level in the supply chain.

The pieces of traceability-related information may be integrated by repeating the following processes: (A) in a product tree to which the target product belongs as a root node, transferring the traceability-related information of the upstream product to the downstream product between the companies in every two adjacent hierarchical levels from a most upstream product to the target product, the most upstream product being a product belonging to the product tree as a leaf node; and (B) integrating the transferred traceability-related information of the upstream product and traceability-related information derived from the downstream product; and acquiring a result of the integrating as the traceability-related information of the downstream product.

The control unit may receive from the account of the downstream company a participation invitation including designation of the upstream company and transmit a participation request to an address of the designated upstream company in a response to the participation invitation. The control unit may generate the account of the upstream company according to a response to the participation request. In this case, the control unit may operate to receive the permission command from the account of the upstream company after the generation of the account of the upstream company.

The storage device may further store transaction data on the upstream products between the upstream company and the downstream company. Either or both of the receiving the permission command from the account of the upstream company and the receiving the linking request from the account of the downstream company can be performed using the transaction data.

Specific embodiments of the present disclosure will be described below with reference to the drawings. The hardware configuration, module configuration, functional configuration, etc. described in each embodiment are not intended to limit the technical scope of the disclosure to these configurations unless otherwise specified.

### First Embodiment

An information processing system according to a first embodiment provides information on products supplied by a supply chain including a plurality of companies. The information on products is typically information on traceability. The companies that belong to the supply chain may be determined as appropriate based on the attributes of products etc.

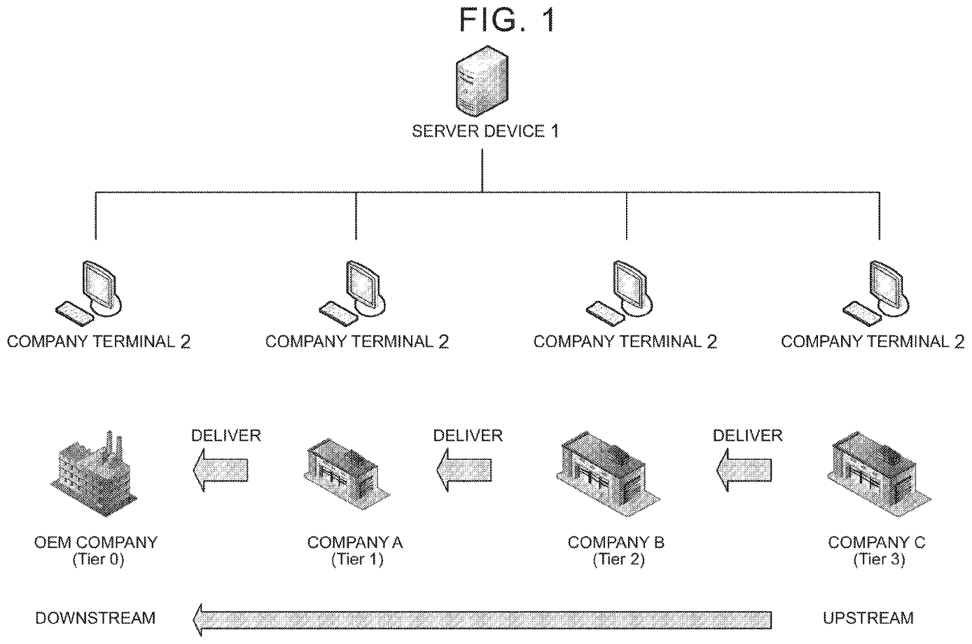

First, the structure of the supply chain will be described. FIG. 1 illustrates an example of the supply chain according to the present embodiment. The supply chain shown in FIG. 1 is constituted by an OEM company and a plurality of supplier companies. It is assumed that the supply chain in the example of FIG. 1 is a supply chain for manufacturing automobiles or automotive products such as batteries. The OEM company assembles a final product. The supplier companies (companies A to C) supply components, materials, assemblies, etc. for manufacturing a final product. The supplier companies each produce one or more products and deliver the products to a company located one hierarchical level below. The companies repeat this process, and the final product is obtained in the final step (i.e., the OEM company).

In the hierarchical levels of the supply chain of the present embodiment, the side that delivers a product will be referred to as “upstream side,” and the side that purchases the product and produces a new product will be referred to as “downstream side.” A company located on the upstream side will be herein referred to as “upstream company,” and a company located on the downstream side will be herein referred to as “downstream company.” Products produced by the upstream company will be referred to as “upstream products,” and products produced by the downstream company will be referred to as “downstream products.” An upstream product is incorporated in a downstream product. In the present embodiment, the hierarchical levels in the supply chain will be referred to as “tiers.” Tier 0 is the lowest hierarchical level (corresponding to the OEM company) at which the final product is assembled, followed by Tiers 1, 2, and 3 in this order with Tier 3 on the most upstream side. A downstream company may become an upstream company depending on from which hierarchical level the company is looked at. For example, the company B in Tier 2 is a downstream company in relation to Tier 3, but is an upstream company in relation to Tier 1. The definitions of the upstream company and the downstream company may thus vary from hierarchical level to hierarchical level.

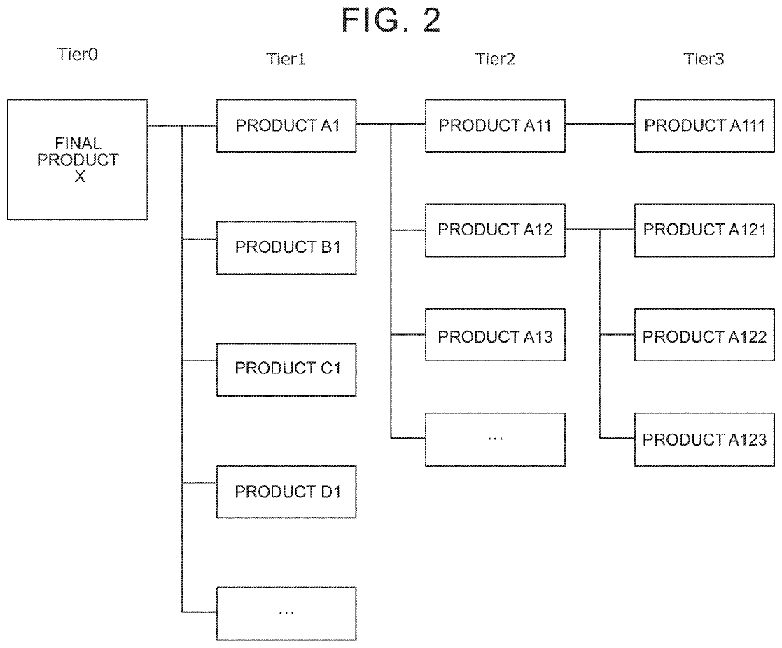

FIG. 2 illustrates relationships among products supplied by the supply chain. Supply relationships among a plurality of products constituting a final product X are represented by a tree diagram. In this example, the final product X is produced by assembling products A1, B1, C1, D1, etc. The product A1 is produced by assembling products A11, A12, A13, etc. In this way, relationships among a plurality of products constituting a final product can be represented by a tree diagram in which the individual products serve as nodes. A tree diagram for a specific final product will be hereinafter referred to as “product tree.”

A server device 1 according to the present embodiment collects pieces of information on products produced by the companies (hereinafter referred to as “product information”) and information for linking the pieces of product information from terminals associated with the companies (company terminals 2), and generates the product tree based on these pieces of information. The product information includes information on traceability (e.g., information on the amount of greenhouse gas emissions; hereinafter referred to as “traceability-related information”). Carbon footprints etc. can be traced by tracing the product tree.

As shown in FIG. 1, the information processing system according to the present embodiment includes the server device 1 and a plurality of company terminals 2.

The company terminals 2 are associated with the companies constituting the supply chain. Any number of terminals may be associated with each company. Terminals associated with a target company may include a terminal of a company (e.g., an agency company) that performs operations related to the target company.

The server device 1 collects pieces of information for generating a product tree from the company terminals 2, and generates the product tree based on the collected pieces of information. The server device 1 can execute a process related to traceability (typically, a process of calculating the amount of carbon dioxide emissions) based on the generated product tree. The result of execution of the process can be transmitted to the company terminals 2.

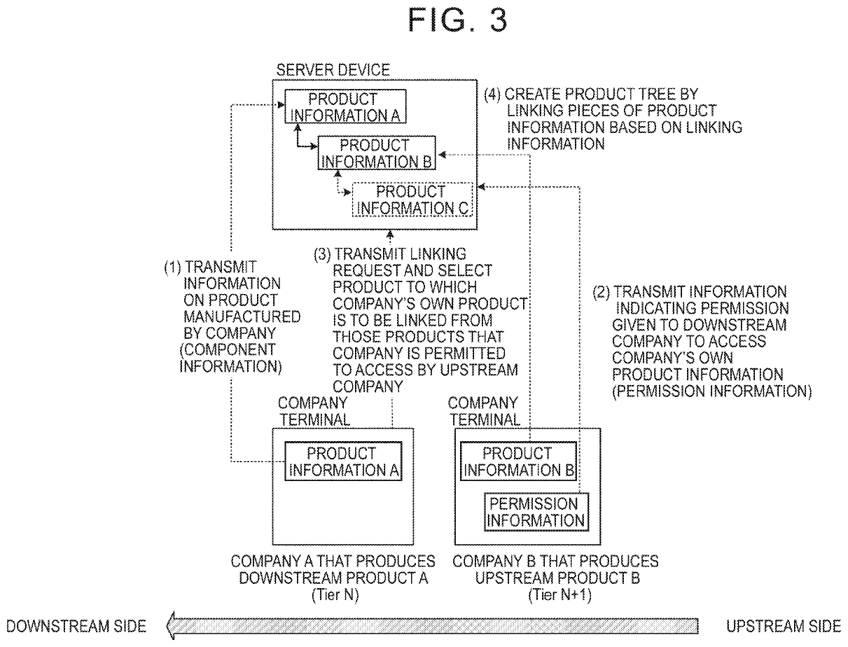

Next, an outline of a process of generating the product tree by the server device 1 will be described with reference to FIG. 3. FIG. 3 shows an outline of a process that is performed between the company terminals 2 and the server device 1. In the example of FIG. 3, it is assumed that there are a downstream company A and an upstream company B at any hierarchical level. It is assumed that the company B produces a product B and delivers it to the company A, and the company A produces a product A using the product B. That is, in the example of FIG. 3, the product B is a child node of the product A on the product tree.

In order to generate the product tree, the company terminals 2 associated with the companies transmit pieces of information on products produced by the companies to the server device 1. In this example, the company terminal 2 associated with the company A transmits product information on the product A (hereinafter referred to as “product information A”) to the server device 1. Similarly, the company terminal 2 associated with the company B transmits product information on the product B (hereinafter referred to as “product information B”) to the server device 1. The pieces of product information from the companies are stored in the server device 1.

An operation for linking the pieces of product information stored in the server device 1 is performed by the company terminal 2. In one example, a person in charge from a downstream company logs into the server device 1 from the company terminal 2 by using an account of the downstream company, and selects an upstream product to which a downstream product that is the product of the downstream company is to be linked. In this way, the pieces of product information are linked from the downstream product to the upstream product. The server device 1 links the pieces of product information together based on the selection.

However, if all the products in the supply chain and all the pieces of information on the products are presented as options for the selection of the upstream product to which the downstream product is to be linked, the confidentiality will be lost for information on the companies constituting the supply chain and information on the products produced by the companies. Further, it may be inappropriate to disclose the entire product tree to one supplier.

Therefore, the server device 1 according to the present embodiment grants the downstream company access to the product information on the upstream product in advance in response to a request from the upstream company. The server device 1 permits reference from the downstream company within the range of the access privilege.

In the example of FIG. 3, the company terminal 2 associated with the upstream company B transmits to the server device 1 a request (information) instructing to “grant the company A access to the product information B.” When the server device 1 receives a linking request from the company terminal 2 associated with the company A, the server device 1 provides only a list of pieces of product information the company A is authorized to access, and prompts the company A to select product information to which the product information of the company A is to be linked. When the company terminal 2 associated with the company A requests reference to the product tree, the server device 1 provides the company terminal 2 with the product tree in which information other than the information that the company A is authorized to access is concealed. The information on irrelevant companies and products can thus be concealed.

### Hardware Configurations

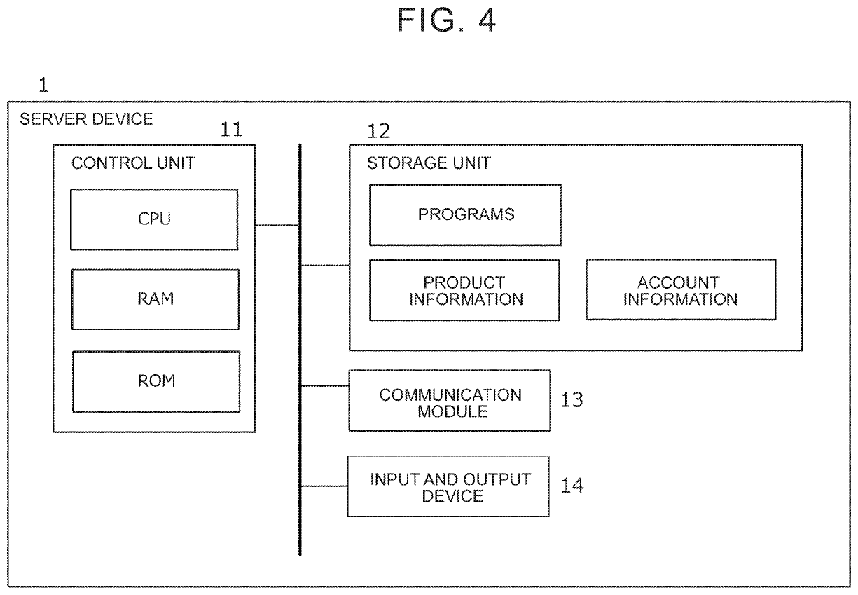

Next, the hardware configurations of the devices constituting the system will be described. FIG. 4 schematically shows an example of the hardware configurations of the server device 1 according to the present embodiment. The server device 1 is a computer including a control unit 11, a storage unit 12, a communication module 13, and an input and output device 14.

The server device 1 may be a computer including a processor (e.g., a central processing unit (CPU), a graphics processing unit (GPU), etc.), a main storage device (e.g., a random access memory (RAM), a read-only memory (ROM), etc.), and an auxiliary storage device (e.g., an erasable programmable read-only memory (EPROM), a hard disk drive, a removable medium, etc.). An operating system (OS), various programs, various tables, etc. are stored in the auxiliary storage device. The programs stored in the auxiliary storage device are executed so that various functions (software modules) can be implemented to meet a predetermined purpose as described later. Par or all of the functions may be implemented as hardware modules by a hardware circuit such as an application specific integrated circuit (ASIC) or a field programmable gate array (FPGA).

The control unit 11 is an arithmetic unit that implements various functions of the server device 1 by executing a predetermined program. The control unit 11 can be implemented by, for example, a hardware processor such as a CPU. The control unit 11 may include a RAM, a ROM, a cache memory, etc.

The storage unit 12 is a means for storing information, and is a storage medium such as a RAM, a magnetic disk, or a flash memory. The storage unit 12 stores programs to be executed by the control unit 11, data to be used by the programs, etc. A database is constructed in the storage unit 12 and stores pieces of product information collected from the company terminals 2 and pieces of account information related to the companies. This will be described in detail later.

The communication module 13 is a communication interface for connecting the server device 1 to a network. The communication module 13 may include, for example, a network interface board and a wireless communication interface for wireless communication. The server device 1 can perform data communication with other computers (e.g., the company terminals 2) via the communication module 13.

The input and output device 14 is a means for receiving an input operation performed by an operator and presenting information to the operator. Specifically, the input and output device 14 includes input devices such as a mouse and a keyboard, and output devices such as a display and a speaker. The input and output device may be an integrated device such as a touch panel display.

In the specific hardware configuration of the server device 1, any component may be omitted, replaced, or added as appropriate depending on embodiments. For example, the control unit 11 may include a plurality of hardware processors. The hardware processor may be a microprocessor, an FPGA, a GPU, etc. The input and output device 14 may be omitted, or an input and output device other than the illustrated one (e.g., an optical drive) may be added. The server device 1 may be constituted by a plurality of computers. In this case, the hardware configurations of the computers may be or may not be the same.

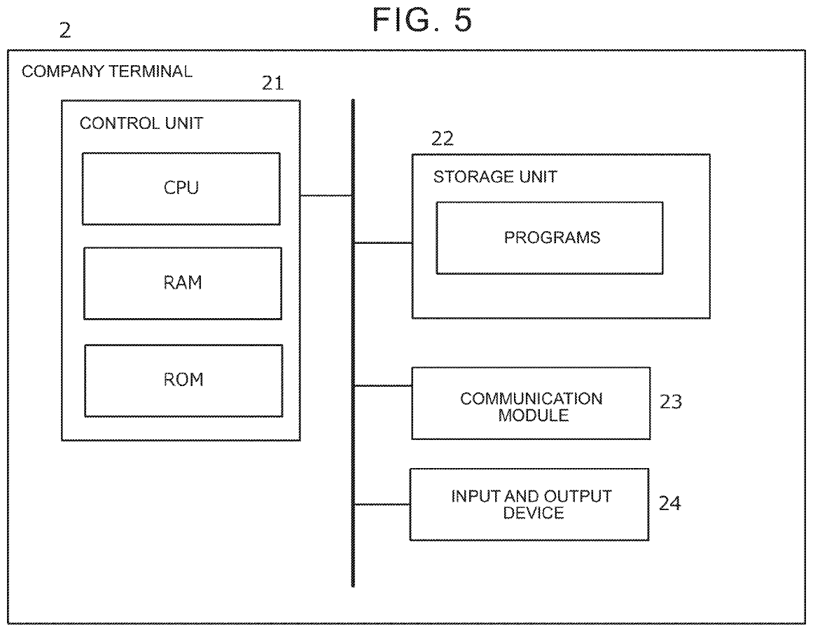

FIG. 5 schematically shows an example of the hardware configuration of the company terminal 2 according to the present embodiment. The company terminal 2 is a computer including a control unit 21, a storage unit 22, a communication module 23, and an input and output device 24.

Similarly to the server device 1, the company terminal 2 may be a computer including a processor (e.g., a CPU, a GPU, etc.), a main storage device (e.g., a RAM, a ROM, etc.), and an auxiliary storage device (e.g., an EPROM, a hard disk drive, a removable medium, etc.). Part or all of the functions (software modules) may be implemented as hardware modules by a hardware circuit such as an ASIC or an FPGA.

The control unit 21 is an arithmetic unit that implements various functions (software modules) of the company terminal 2 by executing a predetermined program. The control unit 21 can be implemented by, for example, a hardware processor such as a CPU. The control unit 21 may include a RAM, a ROM, a cache memory, etc.

The storage unit 22 is a means for storing information, and is a storage medium such as a RAM, a magnetic disk, or a flash memory. The storage unit 22 stores programs to be executed by the control unit 21, data to be used by the programs, etc.

The communication module 23 is a communication interface for connecting the company terminal 2 to a network. The communication module 23 may include, for example, a network interface board and a wireless communication interface for wireless communication. The company terminal 2 can perform data communication with other computers (e.g., the server device 1) via the communication module 23.

The input and output device 24 is a means for receiving an input operation performed by an operator and presenting information to the operator. Specifically, the input and output device 24 includes input devices such as a mouse and a keyboard, and output devices such as a display and a speaker. The input and output device may be an integrated device such as a touch panel display.

In the specific hardware configuration of the company terminal 2, any component may be omitted, replaced, or added as appropriate depending on embodiments, as in the server device 1.

### Software Configurations

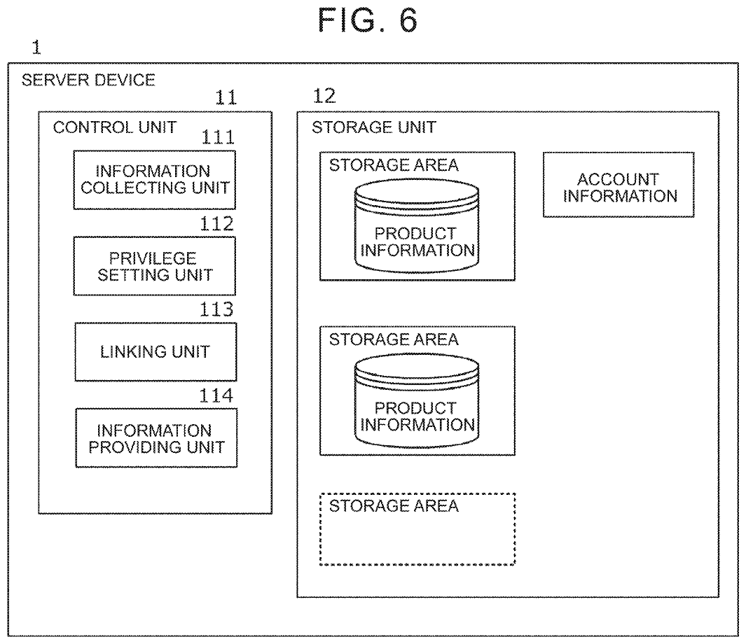

Next, the software configurations of the devices constituting the system will be described. FIG. 6 schematically shows the software configuration of the server device 1 according to the present embodiment. In the present embodiment, the control unit 11 includes the following four software modules: an information collecting unit 111, a privilege setting unit 112, a linking unit 113, and an information providing unit 114. The software modules may be implemented by the control unit 11 (CPU) executing programs stored in the storage unit 12. Information processing that is executed by the information collecting unit 111, the privilege setting unit 112, the linking unit 113, and the information providing unit 114 is synonymous with information processing that is executed by the control unit 11.

The information collecting unit 111 performs a process of receiving pieces of product information transmitted from the company terminals 2 and storing the pieces of product information in the storage unit 12. The privilege setting unit 112 receives information for setting a privilege to access the pieces of product information (hereinafter referred to as “permission information”) from the company terminals 2. The privilege setting unit 112 performs a process of setting a privilege to access the pieces of product information stored in the storage unit 12 based on the received information.

The linking unit 113 interacts with the company terminals 2 to acquire information for linking the pieces of product information from the company terminals 2. The linking unit 113 performs a process of writing information indicating a linking relationship for the pieces of product information stored in the storage unit 12 based on the acquired information. The linking unit 113 performs a process of receiving a request to add termination information and, in response to the request, adding the termination information to the pieces of product information stored in the storage unit 12. A product tree is created by reflecting the linking and the termination. That is, creating the product tree includes saving the linking information and the termination information in the storage unit 12. The linking unit 113 generates the product tree based on the results of the linking and termination.

The information providing unit 114 executes information processing related to the product tree and outputs the results of executing the information processing. The information processing related to the product tree may include a process of performing calculations on traceability of the product tree. Outputting the results of executing the information processing may include a process of providing information on the generated product tree to the company terminals 2. In one example, the information providing unit 114 generates information on the product tree and outputs the generated information on the product tree.

In the present embodiment, the storage unit 12 includes a plurality of logical storage areas. Different access privileges can be set for the storage areas. For example, the company A may be authorized to access one storage area, the company B may be authorized to access another storage area, and both the companies A and B are authorized to access still another area. The privilege setting unit 112 sets the access privileges by storing the pieces of product information received from the company terminals 2 in appropriate storage areas. A specific processing method will be described later.

The storage unit 12 stores account information. In the present embodiment, an operator of each company logs into the server device 1 via the company terminal 2 using an account of the corresponding company, so that interaction between the server device 1 and the company terminal 2 is performed. The account information is information on accounts associated with the companies constituting the supply chain. Logging in using an account is an example of the company associated with the account accessing the server device 1. The method for accessing the server device 1 is not limited to this example, and may be selected as appropriate depending on embodiments.

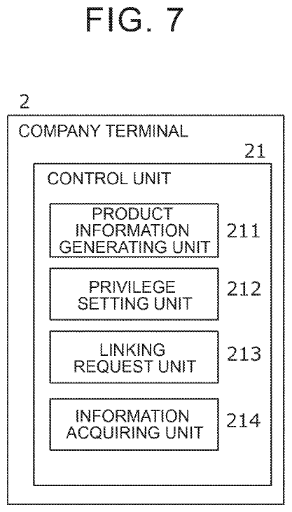

FIG. 7 schematically shows the software configuration of the company terminal 2 according to the present embodiment. In the present embodiment, the control unit 21 includes the following four software modules: a product information generating unit 211, a privilege setting unit 212, a linking request unit 213, and an information acquiring unit 214. The software modules may be implemented by the control unit 21 (CPU) executing programs stored in the storage unit 22. Information processing that is executed by the product information generating unit 211, the privilege setting unit 212, the linking request unit 213, and the information acquiring unit 214 is synonymous with information processing that is executed by the control unit 21.

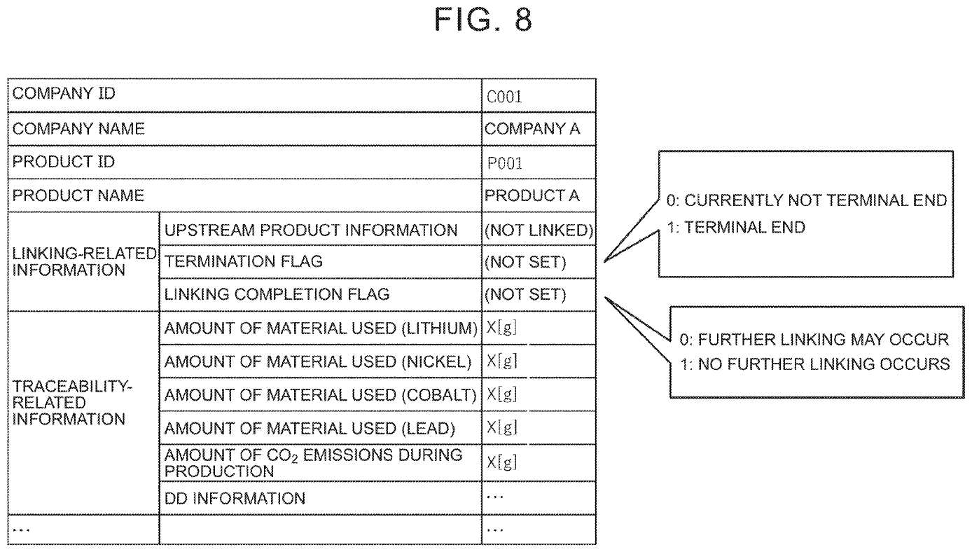

The product information generating unit 211 generates information on a product of a company associated with the company terminal 2 (product information). FIG. 8 shows an example of the product information generated by the product information generating unit 211. The product information may be input via a device operator. In the present embodiment, the product information includes the following fields: company identification (ID), company name, product ID, and product name. The company ID and the company name are an identifier and name of a company that produces a target product (i.e., a company that uses the company terminal 2). The product ID and the product name are an identifier and name of the target product.

The product information further includes linking-related information. The linking-related information is information for identifying an upstream product to which the target product is linked. In the present embodiment, the linking-related information includes the following fields: upstream product information, termination flag, and linking completion flag.

The upstream product information field stores information for identifying product information corresponding to the upstream product to which the target product is linked (i.e., a product necessary to produce the target product and incorporated in the target product). The upstream product information field is used when the server device 1 links products. Basically, the target product is not yet linked to the upstream product at the time the product information is generated. Therefore, the upstream product information field need not necessarily store a value indicating the upstream product.

The termination flag field stores a flag indicating whether the target product is a leaf node in the product tree, that is, a node located at the most upstream end (terminal end). In the present embodiment, the plurality of company terminals 2 transmits pieces of product information. Therefore, this flag is used to determine whether a certain product in the product tree is linked to any upstream product or no further linking occurs for the certain product (whether the target product is located at the most upstream end). That is, the termination flag field is used when the server device 1 finalizes the linking between products. Basically, the linking relationship of the target product is not yet finalized at the time the product information is generated. Therefore, the termination flag field may store “0 (currently not the terminal end).” In order to finally generate the product tree, the status of the product information of each company stored in the server device 1 is set to “linked to upstream product” or “termination flag is set to 1.”

The linking completion flag field stores a flag indicating whether the target product has been linked to the upstream product. In the present embodiment, a certain product in the product tree may be linked to a plurality of upstream products. An example of this case includes a case where a product C is produced using a product A and a product B as its components. When the target product is located at an intermediate node rather than at a leaf node, it is difficult to determine whether the linking is completed or the target product is further linked to any other product, based only on whether there is any product to which the target product is to be linked. The product tree cannot be finalized until this determination is made. The linking completion flag is used to identify whether the linking is completed or the target product is further linked to any other product. That is, the linking completion flag is status information indicating whether all the linking is completed. That is, the linking completion flag field is used when the server device 1 finalizes the linking between products. Basically, the linking relationship of the target product is not yet finalized at the time the product information is generated. Therefore, the linking completion flag field may store “0 (further linking may occur).”

Whether the product information has been finalized can be determined by referring to the termination flag for the product information located at a leaf node and by referring to the linking completion flag for the product information located at an intermediate node. The flag stored in the termination flag field (termination flag) is an example of “termination information.”

The product information further includes traceability-related information. In one example, the traceability-related information may include amounts of materials (e.g., upstream products) used per production volume of the product, information on the recycling rate of a predetermined raw material, the amount of greenhouse gases emitted during production of the product, due diligence-related information, or a combination thereof. Examples of the predetermined raw material include lithium, nickel, cobalt, lead, and graphite. The recycling rate may be expressed directly or may be expressed indirectly by, for example, a combination of the total use amount and the amount of recycled materials used. These values are values associated with the process of producing the target product. In the example of FIG. 3, the traceability-related information in the product information A stores the amount of greenhouse gases emitted during the production activities of the product A. The traceability-related information in the product information A does not include information on the processes up to production of the upstream product (e.g., the amount of greenhouse gases emitted until the upstream product B is produced).

The traceability-related information may be selected as appropriate depending on embodiments. In one example, the amount of greenhouse gas emissions (carbon footprint) may include emissions in scope 1, scope 2, and scope 3. Scope 1 emissions may be direct greenhouse gas emissions from a company. Scope 2 emissions may be indirect emissions associated with the use of electricity, heat, and steam supplied by other companies. Scope 3 emissions may be indirect emissions other than the Scope 1 and Scope 2 emissions. In one example, the due diligence-related information may be technical documentation on a product containing a target raw material (e.g., cobalt, natural graphite, lithium, or nickel), indicating that responsible minerals sourcing obligations are met for the amount of raw material contained in the product, a smelter, etc. In another example, the due diligence-related information may include a score indicating the degree to which the obligations are met.

The product information generating unit 211 acquires such information via the operator of the company terminal 2 and transmits it to the server device 1 at any desired timing.

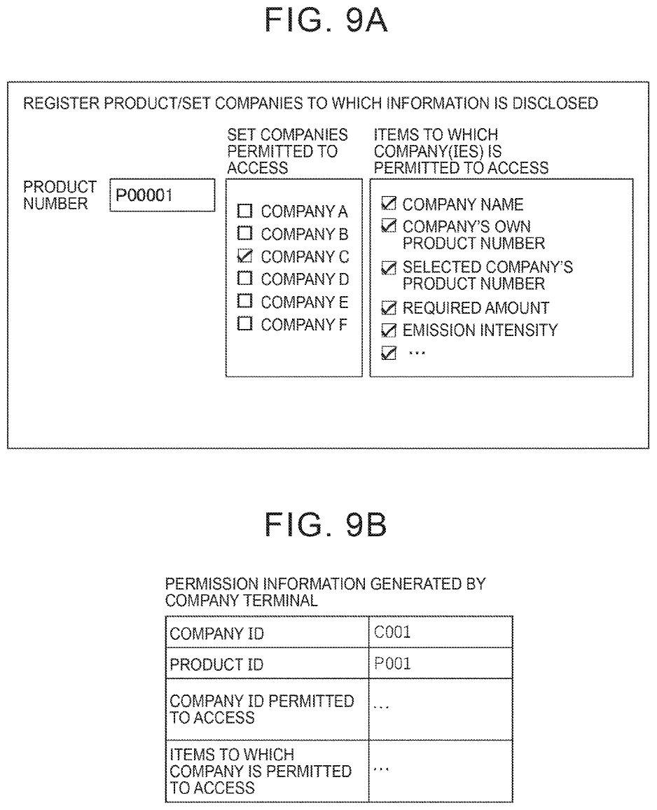

The privilege setting unit 212 designates a downstream company that is permitted to access the product information transmitted from the company terminal 2 to the server device 1. FIG. 9A shows an example of a screen output by the privilege setting unit 212. As shown in the figure, the privilege setting unit 212 receives designation of a downstream company that is permitted to access the product information on any desired company's own product. FIG. 9B shows an example of permission information generated by the privilege setting unit 212 based on received information. The privilege setting unit 212 transmits the permission information to the server device 1 at any desired timing. The permission information is an example of “permission command.” The access privilege may be set for each piece of product information or may be set for each item in the product information (“permitted item” in the figure). This allows partial disclosure of information such as the existence of the product being disclosed but specific information on the materials used, the amounts used, etc. not being disclosed.

The list of companies presented on the screen of FIG. 9A may be a list of companies that have transaction records with the company. Therefore, the server device 1 may store data on past transaction (transaction data) for each company and generate the list of companies based on the transaction data. The transaction data may include, for example, an identifier of a target product, an identifier of a company that produced the product, and a date of transaction.

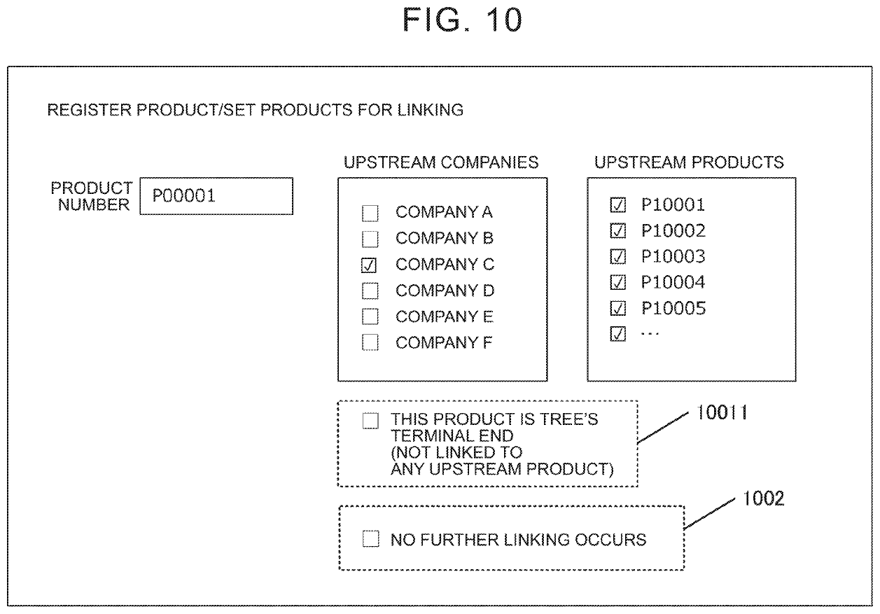

The linking request unit 213 requests the server device 1 to link the company's product information transmitted to the server device 1 to an upstream product. In one example, the linking request unit 213 first transmits a company ID and product ID of the company to the server device 1, and requests linking of product information associated with the product ID. The server device 1 generates a user interface including a list of product information (i.e., linking candidates) the target company is permitted to access, and provides the generated user interface to the company terminal 2. FIG. 10 shows an example of the user interface including a list of products the target company is permitted to access.

The list of products presented in FIG. 10 may be a list of products that have transaction records with the company. The server device 1 may generate the list based also on the stored transaction data.

Subsequently, the linking request unit 213 prompts the operator to select an upstream product to which the product is to be linked from the list. The linking request unit 213 transmits to the server device 1 a pair of the identifier of the product (downstream product) to be linked to the upstream product and the identifier of the upstream product to which the product is to be linked. The server device 1 can link the pieces of product information according to this.

When there is no upstream product to which the target product is to be linked, this can be indicated by, for example, marking a checkbox represented by sign 1001 in FIG. 10. In this case, pieces of product information are not linked, and the server device 1 sets the termination flag of the corresponding product information to “1.” When there is an upstream product to which the target product is to be linked, that is, when the node associated with the target product is not a leaf node, the operation of marking the checkbox is prohibited.

When no further linking is performed for the target product, this can be indicated by marking a checkbox shown by sign 1002 in FIG. 10. In this case, the server device 1 sets the linking completion flag of the corresponding product information to “1.” When the termination flag is set to “1,” the corresponding product information is the terminal end, and is therefore excluded from the linking targets. In this case, the linking completion flag may be handled in any desired manner. In one example, the linking completion flag may be set to “1” in response to the termination flag being set to “1.” In another example, the linking completion flag may remain at “0” and be ignored when the termination flag is set to “1.”

As described above, the linking request unit 213 issues either (1) a request to link the target product and the upstream product or (2) a request to set the termination flag indicating that the target product is the terminal end of the supply chain. When declaring completion of linking, the linking request may include a request to set the linking completion flag indicating that no further linking occurs for the target product. The request (1) is an example of “first request,” and the request (2) is an example of “second request.” The server device 1 can thus finalize the state of the product tree.

The information acquiring unit 214 requests the server device 1 to provide the product tree and outputs the information transmitted from the server device 1.

### Details of Process

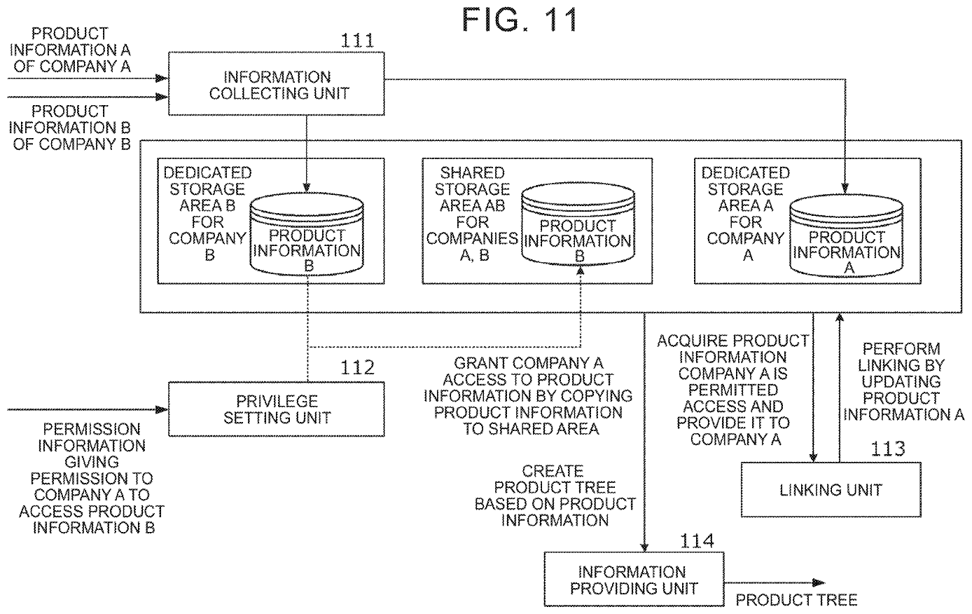

Next, a process to be performed by the server device 1 and the company terminal 2 will be described in detail. FIG. 11 shows an example of the flow of a process that is performed by the server device 1 based on a request from the company terminal 2. The process that is performed by the server device 1 can roughly be divided into the following four phases.
(1) First phase of receiving product information transmitted from the company terminal 2 and storing the received product information
(2) Second phase of receiving permission information transmitted from the company terminal 2 and setting a privilege to access the product information based on the received permission information
(3) Third phase of linking pieces of product information by interacting with the company terminal 2
(4) Fourth phase of providing information on a product tree based on the linking results

In the example of FIG. 11, a company A is a downstream company and a company B is an upstream company. A product produced by the company A will be referred to as “product A,” and a product produced by the company B will be referred to as “product B.” Product information associated with the product A will be referred to as “product information A,” and product information associated with the product B will be referred to as “product information B.”

In the first phase, the information collecting unit 111 of the server device 1 acquires product information from the product information generating unit 211 of the company terminal 2. In the example of FIG. 11, the server device 1 acquires the product information A from the company terminal 2 associated with the company A, and acquires the product information B from the company terminal 2 associated with the company B. The information collecting unit 111 saves the product information A in a storage area only the company A is authorized to access (hereinafter referred to as “storage area A”). The information collecting unit 111 saves the product information B in a storage area that only the company B is authorized to access (hereinafter referred to as “storage area B”). In this way, the information collecting unit 111 saves the product information transmitted from any company in a dedicated storage area only the company is authorized to access.

In the second phase, the privilege setting unit 112 of the server device 1 receives permission information from the privilege setting unit 212 of the company terminal 2, and sets a privilege to access the product information based on the received permission information. As shown in FIG. 9B, the permission information is information in which a product is associated with a company permitted to access product information of the product.

In the example of FIG. 11, it is assumed that the privilege setting unit 112 receives permission information indicating that the downstream company A is permitted to access the product information B of the upstream company. In this case, the privilege setting unit 112 copies the product information B stored in the storage area B to a storage area both of the companies A and B are authorized to access (hereinafter referred to as “storage area AB”). The product information B can thus be made accessible to both the company A and the company B. When no access privilege is set for a specific item in the product information, the item is excluded from being copied to the storage area AB.

In the following description, a storage area only a specific company is authorized to access will be referred to as “dedicated storage area,” and a storage area a plurality of companies is authorized to access will be referred to as “shared storage area.”

As described above, the server device 1 copies the product information in response to reception of the permission information from the company terminal 2. It can thus be said that, by transmitting the permission information to the server device 1, the company terminal 2 performs the operation of copying the product information identified by the permission information from the dedicated storage area of the target company to the shared storage area accessible to the downstream company.

In the third phase, the linking unit 113 of the server device 1 receives a linking request from the linking request unit 213 of the company terminal 2, and links the pieces of product information based on the received linking request.

First, the linking unit 113 receives the linking request from the company terminal 2. The linking request is transmitted from the company terminal 2 of the downstream company. In the example of FIG. 11, it is assumed that the company terminal 2 of the company A transmits the linking request. The linking request includes a company ID and a product ID of a target product. The linking unit 113 acquires product information stored in the storage area accessible to this company, and generates a list of the acquired product information. In the example of FIG. 11, the company A can access the product information B stored in the storage area AB. Therefore, the company terminal 2 of the company A can select the product information B as product information to which the product information A is to be linked.

The linking request unit 213 of the company terminal 2 presents the list to the operator and prompts the operator to select products to be linked together. In this example, the product A and the product B are to be linked together. For example, the operator inputs via the input and output device 24 information indicating that the product B is an upstream product for the product A. The linking request unit 213 transmits data for associating the upstream product (product B) and the downstream product (product A) with each other (linking data) to the linking unit 113.

As described with reference to FIG. 8, the product information includes the fields related to the product to which the target product is linked (linking-related information). Based on the linking data, the linking unit 113 stores information associated with the product information B (i.e., the upstream product) in the linking-related information of the product information A. For example, the linking-related information stores the identifier of the upstream product and the identifier of the company that produces the upstream product.

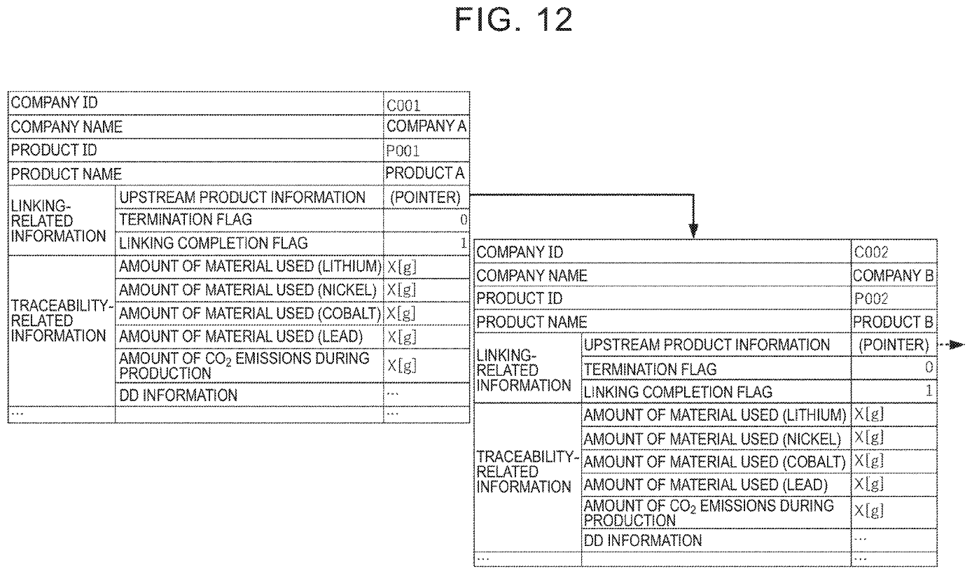

The linking-related information may store, for example, a pointer to the product information to which the target product is linked. FIG. 12 illustrates an example in which a plurality of pieces of product information is linked by pointers. Arrows in the figure represent the pointers. Each pointer indicates, for example, an address of the product information associated with the upstream product. Through the process described above, part of the tree structure is formed with the product information of the downstream product as a parent node and the product information of the upstream product as a child node.

No further linking is performed at the terminal end of the product tree. In this case, the linking request unit 213 transmits data indicating that the product is located at the terminal end of the tree instead of transmitting the linking data. In the example of FIG. 10, the data indicating that the product is the terminal end of the tree is transmitted when the checkbox shown by sign 1001 is marked. When the data is received, the linking unit 113 sets the termination flag field of the corresponding product information to “1.”

When it is clear that no further linking occurs for the target product, the linking request unit 213 includes data indicating this in the linking data and transmits the resultant linking data. In the example of FIG. 10, data indicating that no further linking occurs for the product is transmitted when the checkbox shown by sign 1002 is marked. When this data is received, the linking unit 113 sets the linking completion flag field of the corresponding product information to “1.” When the termination flag is set, both of the flags may be set to “1.”

That is, in the third phase, the linking request unit 213 issues either the following request (A) or (B) to the server device 1:
(A) “request to designate the upstream product to which the target product is to be linked (including a request to set the linking completion flag)” (first request), and
(B) “request to set the termination flag” (second request).

A product tree of a final product is completed when linking or setting of the termination flag has been completed for all the companies belonging to the supply chain. This product tree may be created through any process. In one example, the companies may execute the third phase in a random manner (referred to as “shotgun method”). With this method, the processing load on the server device 1 can be reduced because there is no need to manage execution of the third phase. In another example, the third phase may be executed sequentially from the most upstream company (referred to as “bucket brigade method”). In this case, the server device may permit linking or setting of the termination flag in Tier N after linking in Tier N−1 is completed. With this method, completion of the product tree can be easily managed.

In the fourth phase, the information providing unit 114 of the server device 1 generates information on the product tree based on the stored pieces of product information, and outputs the information on the product tree. Generating the information on the product tree refers to a process of generating various types of information on the products (e.g., information on traceability and an image showing the linking relationship among the products in a tree diagram) after links between nodes are formed by linking the pieces of product information. This process of generating the information on the product tree is an example of information processing on the product tree. In order to generate the information on the product tree, it is necessary that all the pieces of product information have been linked and the termination flags of all the leaf nodes have been set to “1.” The information providing unit 114 can appropriately generate the information when these conditions are satisfied.

As described with reference to FIG. 2, the product tree in the present embodiment is a tree diagram showing the supply relationships among the pieces of product information in the supply chain. The information providing unit 114 can generate an image showing the tree diagram based on the pieces of product information.

When generating the information on the product tree, the information providing unit 114 integrates the pieces of traceability-related information defined in the pieces of product information, and outputs the results of the integration.

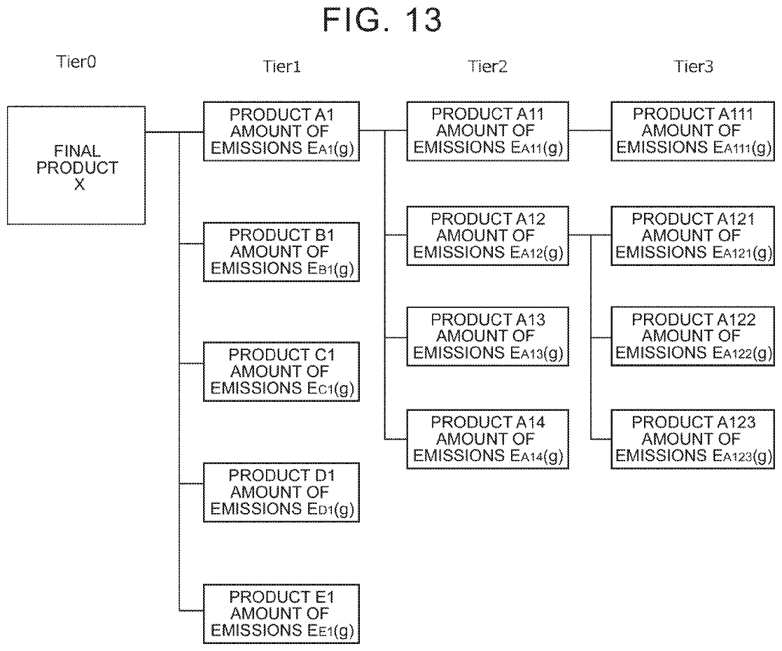

The integration of the pieces of traceability-related information will be described with reference to FIG. 13. FIG. 13 illustrates a plurality of products constituting the final product X and the amounts of carbon dioxide (CO₂) emitted in individual processes for producing the products. For example, it is assumed that E_{A12}(g) of carbon dioxide is emitted in a process of producing the product A12 in the figure. It is also assumed that this product is composed of three upstream products A121 to A123. An upstream product included in a certain product will also be referred to as “incorporated product.” The total amount of carbon dioxide emitted until a certain target product is produced can be obtained by repeating, from the most upstream product at a leaf node to the target product, a process of transferring the amount of CO₂ emissions associated with an upstream product to a downstream product while referring to the product information between companies at two adjacent hierarchical levels.

In the example of FIG. 13, when the target product is A12, the total amount of carbon dioxide emitted until the product A12 is produced can be calculated by summing the amounts of CO₂ emissions associated with the incorporated products (upstream products A121 to A123) and the amount of CO₂ emissions associated with the product A12. That is, the integrated amount of CO₂ emissions for the product A12 is as follows.

$${I}_{A 121} = {E}_{A 121} + {E}_{A 121} \times {U}_{A 121} + {E}_{A 122} \times {U}_{A 122} + {E}_{A 123} \times {U}_{A 123} ( g )$$

In this expression, E_{A121}, E_{A122}, and E_{A123} represent CO₂ emissions per unit amount when producing the products A121, A122, and A123, respectively. U_{A121}, U_{A122}, and U_{A123} represent the amounts of products A121, A122, A123 used for production of the product A12, respectively. The amount used is an example of the amount of material used per production volume of the product in the traceability-related information. The amount of CO₂ emissions of the final product (product of the most downstream company) can be obtained by sequentially performing the above calculation from the product of the most upstream company to the final product.

The same applies to the case where the target product is the product A1. When the target product is A1, the total amount of carbon dioxide emitted during the manufacturing activities until the product A1 is produced can be calculated by integrating the amount of CO₂ emissions associated with the product A1 and the amounts of CO₂ emissions associated with the incorporated products A11, A12, A13, and A14.

The integrated value may be stored in the storage unit 12 separately from the product information or may be included as part of the product information. That is, the product information associated with the product A12 may hold both E_{A12} that is the amount of emissions in the process alone and I_{A12} that is the integrated amount of emissions.

The traceability-related information after the integration is reused when performing integration for a downstream product. By executing this process at each hierarchical level starting from the most upstream side, the traceability-related information (e.g., the cumulative amount of CO₂ emissions) is sequentially transferred in the downstream direction. As the traceability-related information is finally transferred to the final product, the traceability-related information for the entire period until the final product is produced (e.g., the total amount of CO₂ emissions) can be obtained.

The product information that is referred to when integrating the pieces of traceability-related information is sometimes stored in both the dedicated storage area and the shared storage area. In this case, it is preferable to refer to the product information stored in the dedicated storage area. This is because items the downstream company is not permitted to refer to may be omitted from the product information stored in the shared storage area.

When the target product information is stored in both the dedicated storage area and the shared storage area, it is preferable to write the result of the integration to the shared storage area. This is because the downstream company cannot refer to the result of the integration if it is written to the dedicated storage area. By writing the result of the integration to the shared storage area, the downstream company having an access privilege can refer to the result of the integration. The downstream company can refer to the result of the integration, but cannot refer to the traceability-related information specific to the upstream product (e.g., the amount of CO₂ emissions during the production process of the upstream product) because it is not written to the shared storage area unless permitted by the upstream company (e.g., in the screen of FIG. 9A).

As described above, when generating the information on the product tree, the information providing unit 114 repeats, from the most upstream side to the most downstream side, the process of sequentially integrating the pieces of traceability-related information defined in the pieces of product information. In the above example, the amount of carbon dioxide emissions is described as an example of the integration target. However, the traceability-related information that is the integration target may be a recycling rate of a predetermined raw material, a score for due diligence, etc. When the traceability-related information is a numerical value, the integration may be performed by numerical calculation. When the traceability-related information is information other than a numerical value (e.g., due diligence-related information), the integration may simply be information collection.

The traceability-related information need not necessarily be included in the product information. For example, the product information may include information indicating the location of the traceability-related information of the corresponding product (hereinafter referred to as “location information”; typically an address or a pointer). In this case, the integration may be collection of the location information included in the product information.

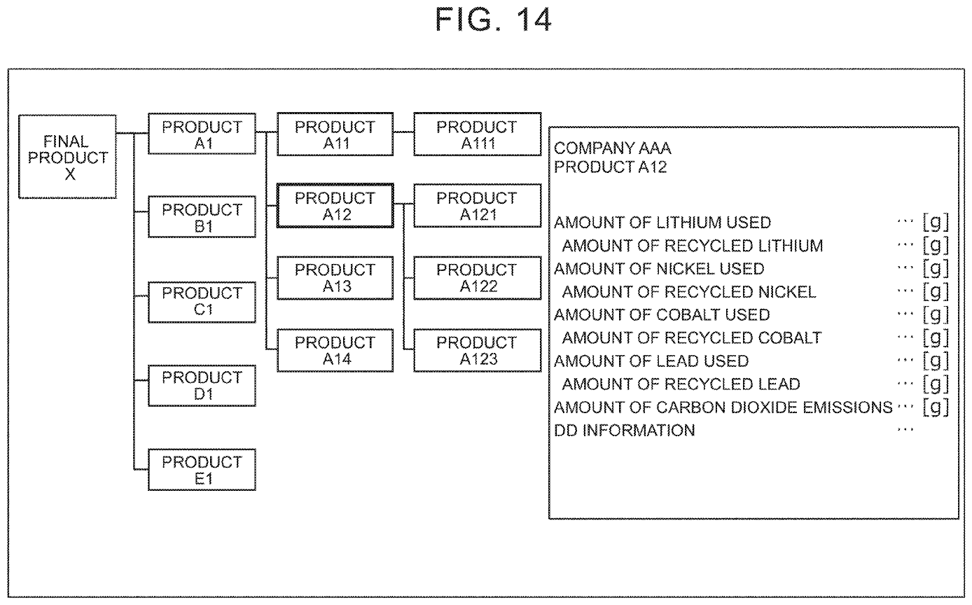

The information providing unit 114 may output the generated product tree in an image format. The information providing unit 114 may simultaneously output the traceability-related information associated with any product. FIG. 14 shows an example of a screen in which the product tree is output as an image. The illustrated screen includes an image showing a tree diagram of the supply relationships among the products constituting the final product. When any product is selected, the traceability-related information associated with the product or the result of integration of the pieces of traceability-related information for the entire period until the product is produced (e.g., the total amount of carbon dioxide emissions from the most upstream side) can be viewed. Such information can be output via the input and output device 14 of the server device 1 based on an operation performed by the operator of the server device 1.

The information providing unit 114 may provide the generated product tree to the company terminal 2 in response to a request from the company terminal 2 (information acquiring unit 214). It is sometimes inappropriate to disclose the entire product tree to a specific company. Therefore, when providing the product tree to the company terminal 2 associated with a certain company, the information providing unit 114 may perform a process of hiding the range the company is not authorized to access.

In the example of FIG. 13, it is herein assumed that the information providing unit 114 receives a product tree disclosure request from the company terminal 2 associated with the company that produces the product A12. It is also assumed that the company is authorized to access only the products A121, A122, and A123. That is, the company cannot access the pieces of product information on the products other than the three products and the downstream product A1. In this case, the information providing unit 114 provides the company terminal 2 with the product tree in which the pieces of information on the products the company is not authorized to access are hidden.

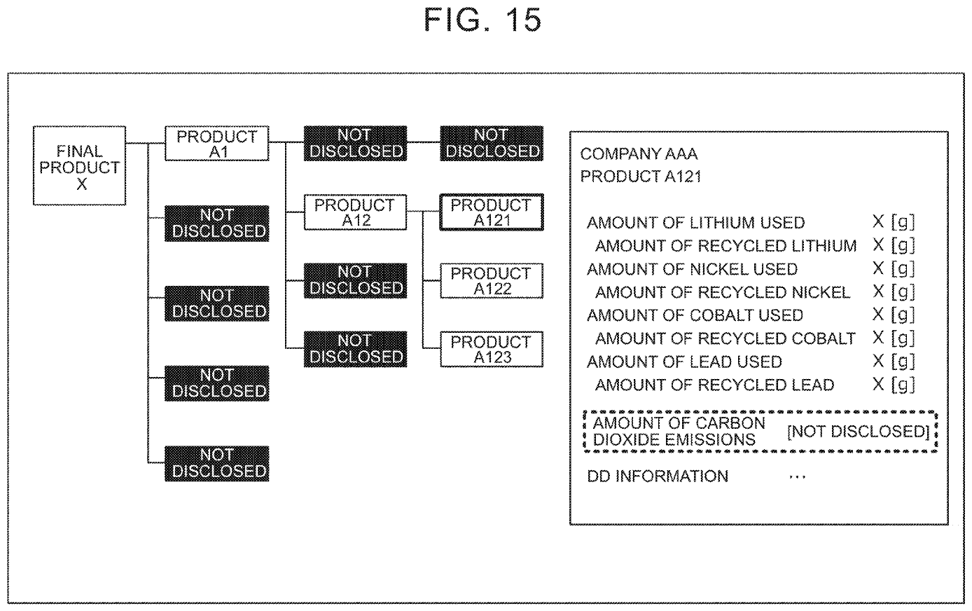

FIG. 15 shows an example of the product tree in which the products the company is not authorized to access are hidden. In this example, the product tree is displayed with detailed information on (or the existence of) the undisclosed products concealed.

In the case where the existence of a product is disclosed and access to the corresponding product information except for a specific item is granted, the concealing process is performed only for the specific item as shown by a dashed line in the figure. In the illustrated example, the amount of carbon dioxide emissions during production of the product A121 is hidden.

Even if the tree includes products (or items) the company is not authorized to access, this does not affect the integration of the pieces of traceability-related information. In the illustrated example, the amount of carbon dioxide emissions for the product A121 is hidden. However, this does not affect the process of calculating the total amount of carbon dioxide emissions for the product A12.

### Process Flow

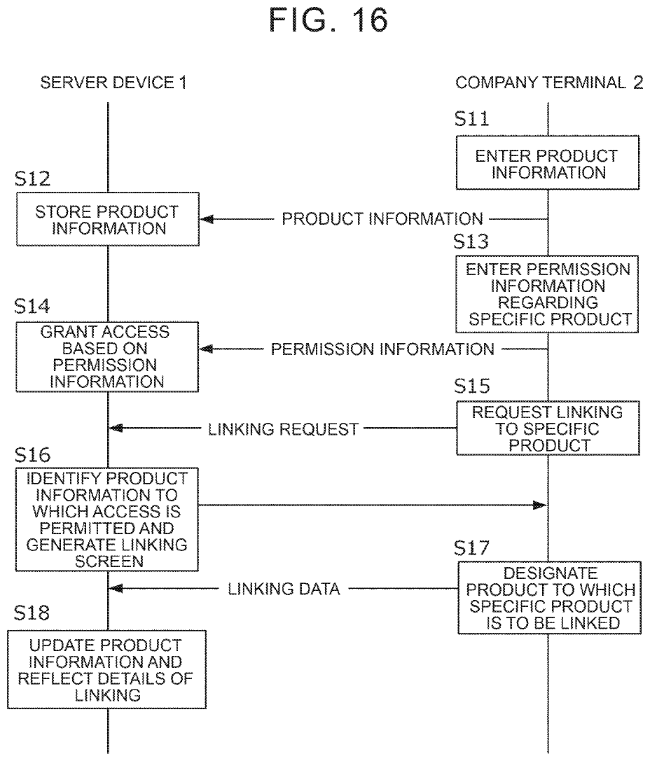

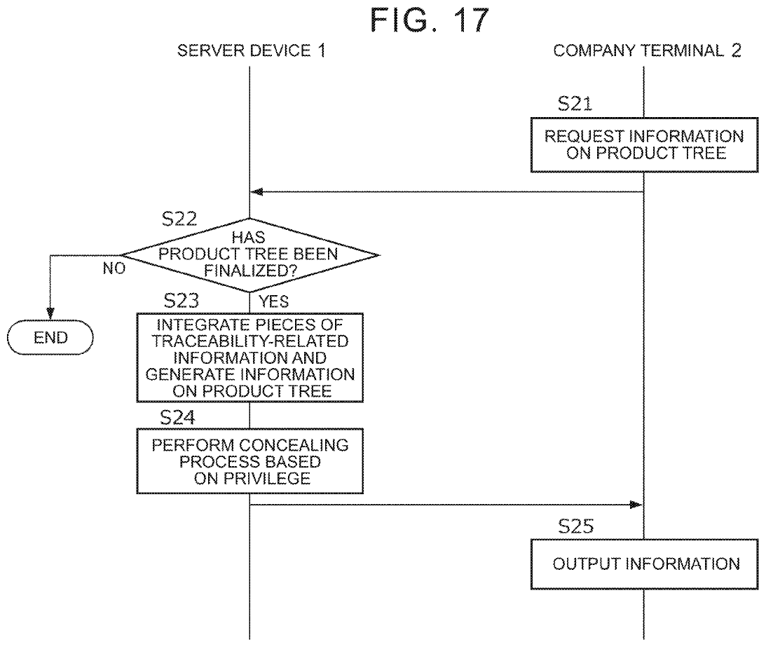

Next, the flow of a process that is executed by the server device 1 and the company terminal 2 will be described with reference to FIGS. 16 and 17. FIG. 16 is a sequence diagram corresponding to the first to third phases.

In one example, interaction between the server device 1 and the company terminal 2 is started when the operator of each company logs into the server device 1 via the company terminal 2 by using the account of the corresponding company. In this example, it is assumed that the operator of each company logs into the server device 1 by using the company's account.

In step S11, the product information generating unit 211 of the company terminal 2 first acquires the company's product information via the operator, and transmits the acquired product information to the server device 1. The transmitted product information is received by the server device 1 (information collecting unit 111) and stored in the storage unit 12 (step S12). At this time, the information collecting unit 111 saves the product information in a storage area only the company that produces the corresponding product is authorized to access.

In step S13, the privilege setting unit 212 of the company terminal 2 receives, via the operator, input of information designating a downstream company permitted to access the product information transmitted in step S11 (permission information). In this step, such a user interface screen as that described with reference to FIG. 9A may be provided to designate a combination of any product and a downstream company permitted to access the product information. The received permission information is transmitted to the server device 1.

In step S14, the privilege setting unit 112 of the server device 1 grants access to the target product information based on the received permission information. In this step, as described with reference to FIG. 11, the privilege setting unit 112 grants any desired company access to any desired product information by copying the target product information to a storage area a plurality of companies is authorized to access. When there is no storage area with an appropriate access privilege, a process of creating a new storage area and granting an appropriate company access to the new storage area may be performed.

Additional information may be added when copying the product information in this step. For example, product information generated by an upstream company may include a product number. Since the product number is used by the upstream company, it may not be used by a downstream company as it is. For example, a product number to be used by the downstream company may be added to the copy target product information as the additional information.

In step S15, the linking request unit 213 of the company terminal 2 transmits data requesting the server device 1 to link the product information transmitted to the server device 1 to an upstream product (linking request). The linking request includes the company ID of the company and the product ID of the target product.

In step S16, the server device 1 (linking unit 113) generates a list of products the target company is permitted to access, and provides the company terminal 2 with a user interface screen including the list. The list of products the target company is permitted to access can be extracted from the pieces of product information stored in the storage area the company is authorized to access. In this step, the server device 1 may provide the company terminal 2 with such a user interface screen as that described with reference to FIG. 10 to cause the operator to designate a combination of any product and an upstream product to which the product is to be linked.

In step S17, the linking request unit 213 of the company terminal 2 receives, from the operator, designation of a combination of the target product and the upstream product to which the target product is to be linked. The linking request unit 213 generates data indicating association between the upstream product and the downstream product (linking data), and transmits the generated linking data to the server device 1.

In step S18, the linking unit 113 of the server device 1 updates the stored pieces of product information based on the linking data to reflect the details of the linking between the pieces of product information. The pieces of product information may be linked by storing information on the upstream product (identifier, pointer, etc.) in the linking-related information in the product information of the downstream product.

When there is no downstream company, steps S13 and S14 may be omitted. Similarly, when there is no upstream company (when there is no product to which the target product is to be linked), the process of setting the termination flag may be executed instead of requesting linking of pieces of product information. In this case, steps S15 to S18 are omitted.

FIG. 17 is a sequence diagram corresponding to the fourth phase. In step S21, the company terminal 2 (information acquiring unit 214) first requests the server device 1 to provide information on a product tree. The request includes, for example, the identifier of the target product. The target product may be a final product or any other product (intermediate product).

The server device 1 (information providing unit 114) that has received the request determines whether the product tree has been finalized (step S22). In this step, determination is made that the product tree has been finalized when the following condition is satisfied.

(Condition 1) The termination flags are set to “1” for the pieces of product information at all the leaf nodes.

When the termination flags are set for all the leaf nodes, the product tree can be said to have been finalized.

When even one of the leaf nodes in the product tree does not meet the above condition, further linking may occur for the target product. In this case, the server device 1 (information providing unit 114) may return the determination result to the company terminal 2 and then terminate the process.

Next, the server device 1 (information providing unit 114) generates information on the product tree through the above process (step S23). At this time, the information providing unit 114 executes the process of integrating pieces of traceability-related information defined in the pieces of product information from the most upstream side to the most downstream side. The result of the integration is reflected in each piece of product information.

In step S24, the process of concealing information the target company is not authorized to access is performed based on the access privilege of the target company. For example, when the existence of product information of another company is not disclosed to a certain company, a process of concealing the existence of the product information is executed. When only a specific item in the product information is not disclosed, a process of concealing the content of the item is executed. Information on the product tree subjected to the concealing process is provided to the company terminal 2 (information acquiring unit 214) and is output.

According to the present embodiment, as described above, in the system that collects pieces of product information from the company terminals 2 and generates a product tree, designation of a downstream company permitted to access information on a company's own product is received from each company terminal 2, and pieces of product information are linked based on this designation. Access to the product information is controlled by storing the product information in a plurality of storage areas each company is authorized to access. When providing the product tree to each company terminal 2, the information concealing process is executed within the range of the access privilege of each company. With such a configuration, it is possible to collect pieces of information over the entire supply chain while maintaining confidentiality.

The server device 1 according to the present embodiment holds information indicating whether each piece of product information is the terminal end of the product tree. The server device 1 can therefore determine whether the product tree is completed.

### Modification of First Embodiment

In the first embodiment, determination is made that the product tree has been finalized when the termination flags are set to “1” for the pieces of product information at all the leaf nodes. However, further linking may occur for a product that is linked at an intermediate node. For example, when a certain downstream product is linked to one upstream product, it may further be linked to second and subsequent upstream products.

In consideration of such a case, the determination in step S22 may be made using the following condition in addition to condition 1.

(Condition 2) The linking completion flags are set to “1” for the pieces of product information at all the nodes other than the leaf nodes.

By using both conditions 1 and 2, it is possible to guarantee that the product tree has been finalized.

### Second Embodiment

In the first embodiment, the server device 1 stores the pieces of account information of the companies in the supply chain, and the company terminals 2 log into the server device 1 by using the pieces of account information.

When participation in and withdrawal from the supply chain occur frequently, there is a possibility that the account information cannot be registered in the server device 1 at an appropriate timing. For example, when a downstream company wishes to link the company's own product to an upstream product but the account information of the upstream company is not registered in the system, the linking cannot be performed. This is because there is neither product information associated with the upstream product nor permission to access the upstream product. In a second embodiment, in order to address this issue, account information of a company newly participating in the supply chain is registered based on a request from a company having already participated in the supply chain.

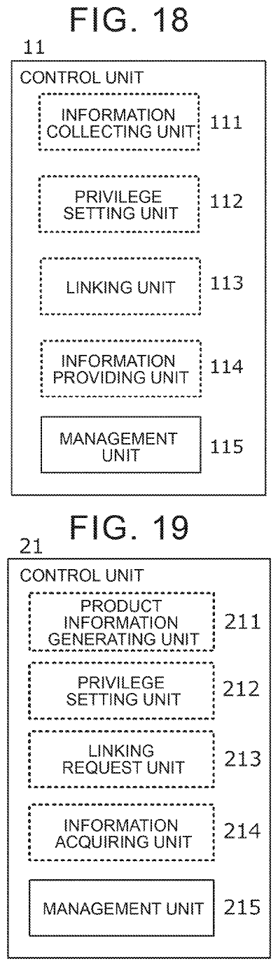

FIG. 18 shows the software configuration of the server device 1 (control unit 11) according to the second embodiment. FIG. 19 shows the software configuration of the company terminal 2 (control unit 21) according to the second embodiment. In the second embodiment, the server device 1 (control unit 11) further includes a software module of a management unit 115. This functional module may be implemented by the control unit 11 (CPU) executing a program stored in the storage unit 12. In the second embodiment, the company terminal 2 (control unit 21) further includes a software module of a management unit 215. This functional module may be implemented by the control unit 21 (CPU) executing a program stored in the storage unit 22.

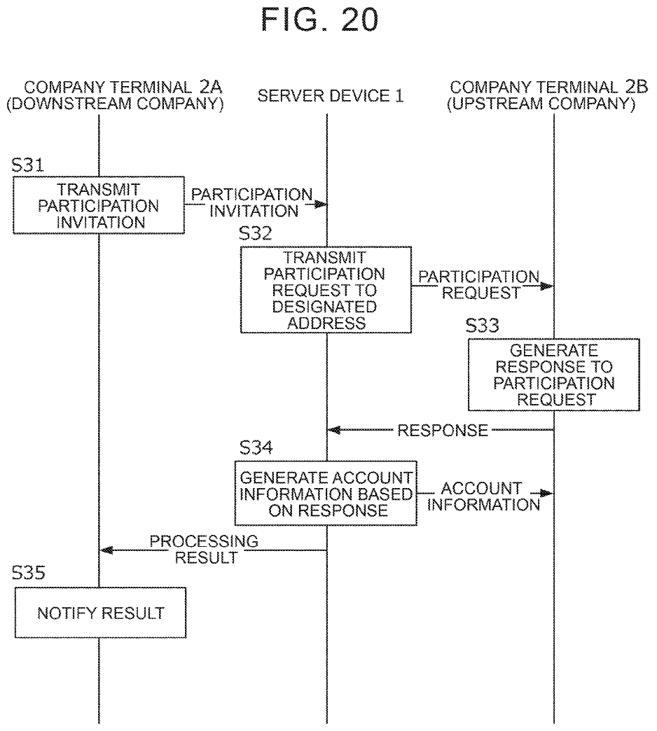

FIG. 20 is a sequence diagram illustrating a process to be performed by the server device 1 and the company terminals 2 in the second embodiment. A company terminal associated with a downstream company will be herein referred to as “company terminal 2A,” and a company terminal associated with an upstream company will be herein referred to as “company terminal 2B.” It is herein assumed that the upstream company has participated in the supply chain but the account information of the upstream company has not been registered in the server device 1.

When the downstream company wishes to link the company's own product to an upstream product, it is necessary to first register the account information of the upstream company in the server device 1 and then have an operator of the upstream company register product information of the upstream product and permission information.

In step S31, the company terminal 2A (management unit 215) first transmits a participation invitation to the server device 1. The participation invitation includes information identifying the upstream company and contact information (e-mail address etc.) of the upstream company. The server device 1 (management unit 115) that has received the participation invitation transmits a participation request to a designated address (step S32). The participation request includes guidance on registration of account information.

The participation request is received by the company terminal 2B (management unit 215). The management unit 215 of the company terminal 2B outputs guidance to the operator based on the received participation request, and receives from the operator a response including whether to participate in the system. The response is transmitted to the server device 1 (management unit 115).

When the response indicates that “willing to participate,” the server device 1 (management unit 115) generates account information associated with the upstream company, notifies the company terminal 2B of the account information, and notifies the company terminal 2A of the result (step S34). When the response indicates that “not willing to participate,” the server device 1 (management unit 115) notifies the company terminal 2A of the result.

The company terminal 2A outputs the result received from the server device 1 (step S35). This allows the operator of the downstream company to know that the upstream company has participated (or is not willing to participate) in the system. The upstream company can, for example, register the product information, register the permission information, or link the product information as described above by using the registered account information.

### Third Embodiment

In the first embodiment, the server device 1 determines in step S22 whether the product tree has been finalized. In a third embodiment, when the product tree has not been finalized, the server device 1 transmits an alert to a company terminal 2 associated with a product that causes this situation.

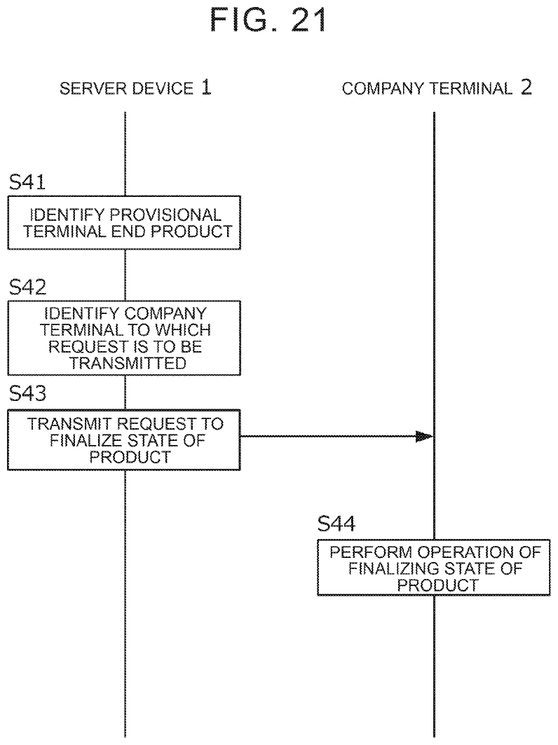

In the third embodiment, when the server device 1 determines in step S22 that the product tree has not been finalized, a process shown in FIG. 21 is executed instead of terminating the process. FIG. 21 is a sequence diagram of the process that is executed when the server device 1 determines in step S22 that the product tree has not been finalized.

In step 541, the server device 1 first identifies a provisional terminal end product. The provisional terminal end product is a product that is located at a leaf node of the product tree and may no longer be the leaf node in the future. Specifically, the provisional terminal end product is a product that is located at a leaf node and for which the termination flag is not “1.”

In step S42, the server device 1 identifies a company terminal 2 to which an alert is to be transmitted. The company to which the alert is to be transmitted is a company that is authorized to make the first and second requests regarding the product information of the provisional terminal end product, and is typically a company that produces the provisional terminal end product.

In step 543, the server device 1 generates the alert and transmits it to the company terminal 2 identified in step S42. The alert includes guidance indicating that the state of the target product has not been finalized. The alert requests (demands) a process of either “setting the termination flag” or “completing the linking of the upstream product.” Completing the linking of the upstream product includes not only performing the linking of the upstream product (e.g., using the screen of FIG. 10), but also declaring that no further linking is performed (e.g., by marking the checkbox 1002).

In step 544, the company terminal 2 that has received the alert outputs the content of the alert. The operator of the company terminal 2 who has viewed the content of the alert accesses the server device 1 and performs an operation for finalizing the state of the target product. When an upstream company that produces a product to which the downstream product is to be linked has not participated in the system, a participation invitation may be transmitted to the upstream company as described in the second embodiment.

As described above, according to the third embodiment, the server device 1 can facilitate finalization of the state of the product tree.

In the present embodiment, the company that produces the provisional terminal end product is illustrated as an example of the company to which the alert is to be transmitted. However, the alert may be transmitted to any other company as long as it is authorized to make the first and second requests regarding the product information of the provisional terminal end product. For example, the company associated with the product information constituting the product tree may be a virtual company or a company whose name and existence are concealed. In this case, the alert may be transmitted to an existing company that manages such a company.

The company to which the alert is to be transmitted need not necessarily be the company that is authorized to make the first and second requests regarding the product information of the provisional terminal end product. For example, when there are a first company that has a privilege over the product information of the provisional terminal end product and a second company that manages this company, the alert may be transmitted to the second company. In this case, the company that has received the alert may issue a reminder to the first company under its management to finalize the state of the product. Data indicating the relationship between such companies may be held in the server device 1.

In the present embodiment, the determination as to whether the product tree has been finalized (step S22) is made based on the request from the company terminal 2. However, the server device 1 may actively make this determination. For example, this determination may be made periodically and, when determination is made that the product tree has been finalized, this may be notified to any desired company terminal 2 (e.g., the company terminal 2 associated with the OEM company that assembles a final product).

The determination as to whether the product tree has been finalized may be made in response to a request from the company terminal 2 associated with the most downstream company (OEM company). In this case, the company terminal 2 associated with the most downstream company may transmit the alert to a target company. In this case, however, there is a possibility that the most downstream company is not authorized to access the identified provisional terminal end product. In this case, the most downstream company cannot know to which company to transmit the alert.

One solution is to relay the alert via other companies located on a path between the provisional terminal end product and the most downstream company. Specifically, the product tree is traced in a direction from the leaf node corresponding to the provisional terminal end product to the root node to identify the most upstream product information the most downstream company is permitted to access. When the product information the most downstream company is permitted to access can be identified, the alert is transmitted to an account of a company that has the product information (company permitted to view the product information). The company that has received the alert relays the alert to a company located on the upstream side. The alert can thus be delivered to a company that has a privilege over the provisional terminal end product. With this method, each company can take measures to finalize the product tree based on the instruction from the most downstream company.

In the present embodiment, the server device 1 generates the alert in response to the presence of the provisional terminal end product (i.e., the product that is located at the leaf node but for which the termination flag is not set). However, the server device 1 may generate the alert in response to the presence of a product for which linking has not been completed. For example, when there is a product that is located at a node other than the leaf node and for which the linking completion flag is not set, the product may be handled similarly to the provisional terminal end product.

### Modifications

The above embodiments are merely illustrative, and the present disclosure may be modified as appropriate without departing from the spirit and scope of the present disclosure. For example, the processes and means described in the present disclosure can be combined as desired as long as no technical contradiction occurs.

In the description of the embodiments, the server device 1 stores the product information in the database. However, the product information may be stored by means other than the database.

The form in which the server device 1 completes the product tree by executing the first to fourth phases is illustrated in the embodiments. However, the roles of the server device 1 may be distributed among a plurality of company terminals 2. For example, the product information may be stored in a distributed database using blockchain infrastructure. In this case, a plurality of company terminals 2 may construct the product information database. In this case, smart contracts may be used to execute the processes in the individual phases. For example, the process in the second phase may be executed in response to permission information being written to the database by an account of a certain company. The process in the third phase may be executed in response to a linking request being written to the database by an account of a certain company.

The storage areas that store the pieces of product information may be distributed among a plurality of company terminals 2. In this case, the dedicated storage area may be provided only in the company terminal 2 of the corresponding company. The shared storage area may be distributed among a plurality of company terminals 2 related to sharing.

The example in which a company in the supply chain permits its adjacent company in the supply chain to access any desired product information is illustrated in the embodiments. However, companies that are not adjacent in the supply chain may share the product information. For example, companies that do not have a direct business relationship may share specific product information when the companies need to share information for the purpose of legal compliance. Even in this case, a shared storage area the companies are authorized to access is provided and necessary data is copied to the shared storage area as in the first embodiment. The shared storage area can be generated based on permission of the company whose product information will be referred to. Secret keys may be used for access control on the dedicated storage areas and the shared storage area. In this case, electronic authentication of the access control may be performed by public key infrastructure. When blockchain infrastructure is used for each storage area, the access control may be performed by smart contracts.

In the description of the embodiments, the second phase is started by transmitting permission information from the company terminal 2 of an upstream company to the server device 1. However, the second phase may be started by the company terminal 2 of a downstream company. In this case, the company terminal 2 of the downstream company may transmit information requesting a privilege to access an upstream product (permission request) to the server device 1, and the company terminal 2 of the upstream company may generate permission information in response to this request. The company terminal 2 of the downstream company may simultaneously transmit the permission request and linking data to the server device 1. When the downstream company can identify a product to which the downstream product is to be linked (by product number etc.), the downstream company may transmit the linking data before the access privilege is given to the downstream company.

Setting of the privilege to access the storage area may be implemented by the operating system of the server device 1, or may be implemented by any other authentication system. For example, a public key cryptosystem may be used. When the system is implemented by using blockchain infrastructure, the access privilege may be given using an electronic key.

In the embodiments, the phase in which the server device 1 receives product information on an upstream product and the phase in which the server device 1 receives permission information associated with the product information are described separately. However, both of them may be received simultaneously. Similarly, in the embodiments, the phase in which the server device 1 receives product information on a downstream product and the phase in which the server device 1 receives a linking request associated with the product information are described separately. However, both of them may be received simultaneously.

In the above embodiments, the companies in the supply chain are described as companies that produce products. However, the companies in the supply chain need not necessarily be the companies that produce products. For example, companies that transport, import, store, or wholesale products may also be included in the companies constituting the supply chain. In one example, part of the companies may be companies that do not perform manufacturing processes, such as trading companies, sales agents, or import agents, and may receive products from companies located one hierarchical level above (upstream companies) and deliver the products to companies located one level below (downstream companies).

In the above embodiments, the supply chain is assumed to be a supply chain of automotive products, the OEM is described as the most downstream company, and the companies that supply components, materials, assemblies, etc. are described as the suppliers. However, the companies belonging to the supply chain are not necessarily limited to these companies. The companies in each stage may be determined as appropriate depending on products etc. The manufacturing activities performed by the companies until the final product is obtained may be determined as appropriate depending on embodiments, and may include all activities that can be performed until the final product is obtained, such as excavation, machining, assembling, transportation, and storage.

In the above embodiments, the access control on each company is implemented by providing the dedicated storage area and the shared storage area. However, the method for implementing the access control is not limited to this example. Any method may be used for the access control.

The form in which an upstream company grants a downstream company access to product information (second phase) and then the downstream company requests the server device 1 to link pieces of product information (third phase) is illustrated in the embodiments. However, these processes may be performed continuously based on a request from the downstream company.

For example, the company terminal 2 of the downstream company transmits a request including information designating a combination of a downstream product and an upstream product that are to be linked (hereinafter referred to as “disclosure request”) to the server device 1. This request is made to request the upstream company to grant the downstream company access to the upstream product and to request the server device 1 to link the pieces of product information of these products.

The server device 1 that has received the disclosure request transfers the received disclosure request to the company terminal 2 of the upstream company. In response to the disclosure request, the company terminal 2 of the upstream company performs step S13 shown in FIG. 16. In one example, the server device 1 that has received the permission information performs step S14 and also performs step S18 without waiting for the linking request. That is, the disclosure request may include the linking request. In step S18, the server device 1 performs a process of linking the pieces of product information identified by the disclosure request. As described above, part of the process shown in FIG. 16 may be omitted.

In another example, the server device 1 may notify the company terminal 2 of the downstream company of the result of step S18 performed automatically. Alternatively, the server device 1 may transmit a notification requesting permission to perform step S18 to the company terminal 2 of the downstream company before step S18 is automatically performed. The server device 1 may perform step S18 based on a permission response from the company terminal 2 of the downstream company. In still another example, the server device 1 may perform step S18 in response to the linking request from the company terminal 2 of the downstream company even when the disclosure request has been made. That is, the disclosure request need not necessarily include the linking request.

In the description of the embodiments, it is assumed that the upstream company and the downstream company are different companies, that is, the upstream product and the downstream product are produced by different companies. In the above embodiments, the most upstream company may be an upstream company, and the most downstream company may be a downstream company. Every company other than the most upstream company and the most downstream company may be both an upstream company and a downstream company. Therefore, in the second phase, the company terminal 2 of each company may regard the company itself (target company) as an upstream company and transmit to the server device 1 a permission command including designation of a downstream company permitted to access product information on the company's own product. The company's own product is an example of a first target product of the target company, and the product information on the company's own product is an example of first product information on the first target product. The server device 1 may set the access privilege in response to the permission command. In the third phase, the company terminal 2 of each company may regard the company itself as a downstream company and transmit to the server device 1 a termination flag setting request or a linking request including selection of product information to which the product information on the company's own product is to be linked from pieces of product information the company is permitted to access by its upstream company. In this case, the company's own product is an example of a second target product of the target company, and the product information on the company's own product is an example of second product information on the second target product. The server device 1 may perform the linking or set the termination flag in response to the linking request or the termination flag setting request. The first target product (target of access permission) and the second target product (target of linking or termination flag setting) may be the same or different. When the first target product and the second target product are the same, the first product information and the second product information may be the same. When the first target product and the second target product are different, the first product information and the second product information may be different.

The above embodiments show an example of calculation of the amount of CO₂ emissions (Carbon Footprint of Products (CFP) value). The CFP value may be calculated by the following formula.

$$Tier N - 1 CFP value = CFP value measured by company in Tier N - 1 + {\sum }_{k} ( CFP value of company k ( Tier N ) \times amount {u}_{k} used in Tier N - 1 )$$

In this formula, the “Tier N−1 CFP value” indicates the result of integrating the CFP value of the upstream company (company k (Tier N)) and the CFP value of the company in Tier N−1. The CFP value measured by the company indicates a CFP value included in the product information of the company. When Tier N is the most upstream company, a “Tier N CFP value” is a CFP value included in the product information of this company. In other cases, the “Tier N CFP value” is the result of integrating a CFP value of an upstream company (Tier N+1) and the CFP value included in the product information of the company. When Tier N is set as the most upstream company (terminal end company) and the calculation is repeated up to N=1, the CFP value of a Tier 0 product (i.e., final product) can be obtained.

In the above embodiments, the server device 1 may calculate the recycling rate and the due diligence (score) together with or instead of calculating the amount of CO₂ emissions (CFP value). The recycling rate may be calculated by the following formula.

$$“ ( Recycling rate of target substance in Tier N - 1 product ) = \{ ( total amount used in Tier N - 1 ) \times ( recycling rate in Tier N - 1 ) + {\sum }_{k} ( total amount used by company k ( Tier N ) \times recycling rate for company k ( Tier N ) \times amount {u}_{k} used in Tier N - 1 ) \} \div \{ total amount used in Tier N - 1 + {\sum }_{k} ( total amount used by company k ( Tier N ) \times amount {u}_{k} used in Tier N - 1 ) \} = \{ amount of recycled material used in Tier N - 1 + {\sum }_{k} ( amount of recycled material used by company k ( Tier N ) \times amount {u}_{k} used in Tier N - 1 ) \} \div \{ total amount used in Tier N - 1 + {\sum }_{k} ) total amount used by company k ( Tier N ) \times amount {u}_{k} used in Tier N - 1 ) \} ”$$

The used amount of recycled material indicates the amount of recycled material used in the target substance. Like the CFP value, the recycling rate of the target substance in the final product can be calculated by performing calculations sequentially from the most upstream company (terminal end company). The due diligence scores (DD scores) can also be integrated by performing calculations similar to those for the CFP value and the recycling rate. In one example, the DD score (integration result) in the final product can be obtained by performing the calculations sequentially from the most upstream company (terminal end company) using DD scores instead of the CFP values.

In the above embodiments, the traceability-related information of each company (Tier N−1) other than the most upstream company may not be stored in the shared storage area between the company and its downstream company, and the integration result of each company (Tier N−1 CFP value and recycling rate of target substance in Tier N−1 product) may be stored in the shared storage area between the company and its downstream company (Tier N−2). This makes it possible to obtain the traceability-related information (integration result) of the final product without disclosing the traceability-related information of each company.

In the above embodiments, it is assumed that each company places an order for a certain material from one company. In the above embodiments, however, the way each company places an order is not limited to this example. At least part of the companies belonging to the supply chain may place an order for the same product from a plurality of upstream companies and use the obtained upstream products selectively for their own products. In the example of FIG. 13, a product A11, a product A12, or a product A13 in Tier 2 may be selectively used for the product A1 in Tier 1. In this case, the server device 1 may hold the linking relationship for each pattern to be used. In the above example, the server device 1 may hold pieces of linking information for the product A1 in Tier 1, such as a pattern 1 “product A11 in Tier 2, . . . ,” a pattern 2 “product A12, . . . ,” and a pattern 3 “product A13, . . . ” The server device 1 may thus perform the calculations (integrations) of the traceability-related information for each pattern. In one example, the server device 1 may output the calculation results for each pattern. In another example, the server device 1 may calculate, based on the calculation result, statistics such as a maximum value, minimum value, average value, variance, standard deviation, and median of the calculation results, and output the calculated statistics.

In the above embodiments, the traceability-related information (in particular, CFP value) may be composed of primary data or may be composed of secondary data (inventory data). The primary data is a measured value, and the secondary data is a reference value to be used when the measured value is not available. In this case, the calculation (integration) of the traceability-related information may include calculating the primary data ratio of the traceability-related information obtained for the final product. The primary data ratio may be calculated by simple ratio calculation, or may be calculated by weighted calculation by replacing the CFP value in the above CFP value calculation formula with the primary data ratio of each company and performing calculations sequentially from the most upstream company.

The process described as being performed by a single device may be divided and performed by a plurality of devices. The processes described as being performed by different devices may be performed by a single device. In a computer system, the hardware configuration (server configuration) that implements functions can be changed flexibly.

The present disclosure may be implemented by supplying computer programs that implement the functions described in the above embodiments to a computer and causing one or more processors of the computer to read and execute the computer programs. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as a magnetic disk (floppy (registered trademark) disk, hard disk drive (HDD), etc.) and an optical disc (compact disc ROM (CD-ROM), digital versatile disc (DVD), Blu-ray disc, etc.); a read-only memory (ROM); a random access memory (RAM); an erasable programmable ROM (EPROM); an electrically erasable programmable ROM (EEPROM); a magnetic card; a flash memory; an optical card; and any type of medium suitable for storing electronic instructions.

What is claimed is:

1-19. (canceled)

20. A server device comprising:
a storage device configured to store, for each of companies included in a supply chain, pieces of product information on products of the companies, the supply chain having a structure of three or more levels, and an upstream company and a downstream company being defined between companies in every two adjacent hierarchical levels of the supply chain; and
a controller configured to execute
receiving, from an account of the upstream company, a permission command including designation of the downstream company permitted to access pieces of first product information, the pieces of the first product information being pieces of information on upstream products of the upstream company,
receiving, from an account of the downstream company, a linking request including selection of the first product information to which second product information is to be linked from the pieces of the first product information the downstream company is permitted to access, the second product information being information on a downstream product of the downstream company, and
generating linking information indicating a linking relationship between the first product information and the second product information that are designated by the linking request received from the account of the downstream company.

21. The server device according to claim 20, wherein:
the product information includes traceability-related information; and
the controller is configured to execute
acquiring first traceability-related information included in product information of one or more incorporated products in a target product and second traceability-related information included in the product information on the target product, the one or more incorporated products being one or more products identified from the linking information related to the target product,
integrating the first traceability-related information and the second traceability-related information, and
outputting a result of the integrating.

22. The server device according to claim 21, wherein:
the first traceability-related information and the second traceability-related information include information on an amount of greenhouse gas emissions; and
the integrating the first traceability-related information and the second traceability-related information includes integrating amounts of the greenhouse gas emissions for the one or more incorporated products and the target product to calculate a total amount of the greenhouse gas emissions related to manufacturing activities performed until the target product is manufactured.

23. The server device according to claim 21, wherein:
the first traceability-related information and the second traceability-related information includes a recycling rate of a predetermined raw material; and
the integrating the first traceability-related information and the second traceability-related information includes integrating recycling rates of the predetermined raw material in the one or more incorporated products and the target product to calculate an overall recycling rate of the predetermined raw material in the target product.

24. The server device according to claim 21, wherein:
the first traceability-related information and the second traceability-related information includes a score for due diligence; and
the integrating the first traceability-related information and the second traceability-related information includes integrating scores for the due diligence of the one or more incorporated products and the target product to calculate an overall score for the due diligence of the target product.

25. The server device according to claim 21, wherein:
the generating linking information includes creating a product tree by associating the first product information and the second product information in such a manner that the upstream product corresponding to the selected first product information is a child node and the downstream product corresponding to the second product information is a parent node; and
the acquiring the first traceability-related information and the second traceability-related information, and the integrating the first traceability-related information and the second traceability-related information includes, in the product tree to which the target product belongs as a root node between the companies in the every two adjacent hierarchical levels from a most upstream product belonging to the product tree as a leaf node to the target product, repeating
(i) transferring the first traceability-related information of the upstream product to the downstream product,
(ii) integrating the transferred first traceability-related information of the upstream product and the second traceability-related information derived from the downstream product, and
(iii) acquiring a result of the integrating as third traceability-related information of the downstream product.

26. The server device according to claim 20, wherein:
the controller is configured to
receive a participation invitation including designation of the upstream company from the account of the downstream company,
transmit a participation request to an address of the designated upstream company in response to the received participation invitation, and
generate the account of the upstream company according to a response to the participation request; and
the receiving the permission command from the account of the upstream company is performed after the generating the account of the upstream company.

27. The server device according to claim 20, wherein:
the storage device is configured to further store transaction data on the upstream product between the upstream company and the downstream company; and
at least one of the receiving the permission command from the account of the upstream company and the receiving the linking request from the account of the downstream company are performed using the transaction data.

28. An information processing method that is performed by a server device, the server device being configured to store, for each of companies included in a supply chain, pieces of product information on products of the companies, the supply chain having a structure of three or more levels, and an upstream company and a downstream company being defined between companies in every two adjacent hierarchical levels of the supply chain, the information processing method comprising:
receiving, from an account of the upstream company, a permission command including designation of the downstream company permitted to access pieces of first product information, the pieces of the first product information being pieces of information on upstream products of the upstream company;
receiving, from an account of the downstream company, a linking request including selection of the first product information to which second product information is to be linked from the pieces of the first product information the downstream company is permitted to access, the second product information being information on a downstream product of the downstream company; and
generating linking information indicating a linking relationship between the first product information and the second product information that are designated by the linking request received from the account of the downstream company.

29. The information processing method according to claim 28, wherein the product information includes traceability-related information, the information processing method further comprising:
acquiring first traceability-related information included in product information of one or more incorporated products in a target product and second traceability-related information included in the product information on the target product, the one or more incorporated products being one or more products identified from the linking information related to the target product;
integrating the first traceability-related information and the second traceability-related information; and
outputting a result of the integrating.

30. The information processing method according to claim 29, wherein:
the first traceability-related information and the second traceability-related information includes information on an amount of greenhouse gas emissions; and
the integrating the first traceability-related information and the second traceability-related information includes integrating amounts of the greenhouse gas emissions for the one or more incorporated products and the target product to calculate a total amount of the greenhouse gas emissions related to manufacturing activities performed until the target product is manufactured.

31. The information processing method according to claim 29, wherein:
the first traceability-related information and the second traceability-related information includes a recycling rate of a predetermined raw material; and
the integrating the first traceability-related information and the second traceability-related information includes integrating recycling rates of the predetermined raw material in the one or more incorporated products and the target product to calculate an overall recycling rate of the predetermined raw material in the target product.

32. The information processing method according to claim 29, wherein:
the first traceability-related information and the second traceability-related information includes a score for due diligence; and
the integrating the first traceability-related information and the second traceability-related information includes integrating scores for the due diligence of the one or more incorporated products and the target product to calculate an overall score for the due diligence of the target product.

33. The information processing method according to claim 29, wherein:
the generating linking information includes creating a product tree by associating the first product information and the second product information in such a manner that the upstream product corresponding to the selected first product information is a child node and the downstream product corresponding to the second product information is a parent node; and
the acquiring the first traceability-related information and the second traceability-related information, and the integrating the first traceability-related information and the second traceability-related information includes, in the product tree to which the target product belongs as a root node between the companies in the every two adjacent hierarchical levels from a most upstream product belonging to the product tree as a leaf node to the target product, repeating
(i) transferring the first traceability-related information of the upstream product to the downstream product,
(ii) integrating the transferred first traceability-related information of the upstream product and the second traceability-related information derived from the downstream product, and
(iii) acquiring a result of the integrating as third traceability-related information of the downstream product.

34. The information processing method according to claim 28, further comprising:
receiving a participation invitation including designation of the upstream company from the account of the downstream company;
transmitting a participation request to an address of the designated upstream company in response to the received participation invitation; and
generating the account of the upstream company according to a response to the participation request, wherein the receiving the permission command from the account of the upstream company is performed after the generating the account of the upstream company.

35. The information processing method according to claim 28, wherein at least one of the receiving the permission command from the account of the upstream company and the receiving the linking request from the account of the downstream company are performed using transaction data on the upstream product between the upstream company and the downstream company.

36. A non-transitory storage medium storing instructions that are executable by one or more processors and that cause the one or more processors to perform functions comprising:
communicating with a server device configured to store, for each of companies included in a supply chain, pieces of product information on products of the companies, the supply chain having a structure of three or more levels, and an upstream company and a downstream company being defined between companies in every two adjacent hierarchical levels of the supply chain;
acquiring, from the server device, pieces of first product information to which access is permitted, the pieces of first product information to which access is permitted being pieces of information on upstream products of the upstream company and being pieces of information the downstream company is permitted to access; and
transmitting to the server device a linking request including selection of the first product information to which second product information is to be linked from the pieces of the first product information to which access is permitted, the second product information being information on a downstream product of the downstream company.

37. The non-transitory storage medium according to claim 36, wherein the functions further comprise transmitting the first product information and the second product information to the server device.

38. The non-transitory storage medium according to claim 36, wherein the functions further comprise transmitting a participation invitation including designation of the upstream company to the server device.
